(19) United States
(12) Patent Application Publication
(10) Pub. No.: US 2025/0197609 A1
(43) Pub. Date: Jun. 19, 2025

(54) ECOFRIENDLY, BIODEGRADABLE BIOLOGICAL POLYSACCHARIDE COMPOSITION FOR PACKAGING MATERIALS

(71) Applicant: Blue Evolution, Inc., Los Altos, CA (US)

(72) Inventors: Gowri Shah, Los Altos, CA (US); Jaime Martin Canton, Los Altos, CA (US); Beau Perry, Los Altos, CA (US)

(73) Assignee: Blue Evolution, Inc., Los Altos, CA (US)

(21) Appl. No.: 18/978,936

(22) Filed: Dec. 12, 2024

Related U.S. Application Data
(60) Provisional application No. 63/609,466, filed on Dec. 13, 2023.

(51) Int. Cl. C08L 5/00; C08K 3/26; C08K 5/1515; C08L 1/02; C08L 3/02

(52) U.S. Cl. CPC C08L 5/00; C08K 3/26; C08K 5/1515; C08L 1/02; C08L 3/02; C08K 2201/005; C08L 2201/08; C08L 2201/14; C08L 2205/025

(57) ABSTRACT

Disclosed are biodegradable compositions, suitable for using in packaging, containing an Ulva polysaccharide, a nanomaterial, a non-Ulva biomass, and a non-phthalate plasticizer, and methods of forming thereof.

### CROSS-REFERENCE TO RELATED APPLICATIONS

This application claims the benefit of priority under 35 U.S.C. § 119(e) to U.S. Provisional Application No: 63/609,466, filed Dec. 13, 2023, which is incorporated herein by reference in its entirety.

### BACKGROUND OF THE DISCLOSURE

Plastic articles are ubiquitous and find use in a wide variety of industries. Their manufacture and disposal stress the environment in several respects. In terms of manufacturing, about 4% of global oil and gas production is devoted to making plastic feedstocks which is the resinous material from which plastic articles are made. And another 3 to 4% of the global oil and gas production is required to make the plastic articles (Hopewell et al., Philos. Trans. R. Soc. Lond. B. Biol. Sci. 364(1526):2115-2126 (2009)).

Plastic products also contribute to significant amounts of long-lasting waste. In 2019, global plastic production reached 368 million metric tons and is predicted to double within 20 years (Walker and Fequet, Trends in Analytical Chemistry 160(116984):1-7 (2023)) and most plastic products are designed for single use, leading to increased global production and unprecedented plastic waste and widespread plastic pollution (Borrelle et al., Science 369(6510):1515-1518 (2020); Lau et al., Science 369(6510):1455-1461 (2020)).

Plastic products are advertised as recyclable. In reality, a mere 9% of global plastic waste is recycled. The remaining 91% is incinerated (about 12%) or deposited into landfills and natural ecosystems (about 79%) (Geyer et al., Sci. Adv. 3(7):e1700782, 1-5 (2017)). To exacerbate the matter, plastic waste does not easily decompose in the environment; natural decomposition of plastic takes about 1000 years (Zahra et al., Waste Manag. 30(3):396-401 (2010)). Biodegradable plastics are being developed in an effort to ameliorate the substantial non-degradation of plastic wastes. Even though some fossil fuel-derived plastics are biodegradable, they also rely on non-renewable feedstocks. Moreover, production of these non-renewable feedstocks causes harmful carbon emissions. Furthermore, decomposition of organic waste from biodegradable plastics in landfills occurs in an anaerobic environment, resulting in the production of methane, a highly flammable greenhouse gas that is 23 times more potent than carbon dioxide. Therefore, there is a critical need for alternatives to plastic feedstocks (resins) capable of manufacture without resorting to fossil fuels, and that will not produce long-lasting wastes.

### SUMMARY OF THE DISCLOSURE

The biodegradable compositions (also referred to herein as composites), and articles made therefrom such as packages, films, and aerosol containers, which all contain an Ulva polysaccharide, and biodegradable articles provided herein, are expected to address the above needs. Among other advantages, they are eco-friendly throughout their lifetime, in that their production, use and disposal all result in low environmental impact.

More specifically, the biodegradable compositions are intended to replace traditional, non-biodegradable plastic compositions, e.g., fossil-fuel derived plastic compositions that are composed of polyethylene terephthalate (PET), high-density polyethylene (HDPE), polyvinyl chloride (PVC), low-density polyethylene (LDPE), polypropylene (PP), polystyrene (PS), polycarbonate (PC), polylactic acid (PLA), and etc. The Ulva polysaccharides are readily and inexpensively extractable from renewable natural sources, namely green algae, and in commercially viable quantities. They generate less CO₂ than fossil fuel-sourced plastics. The compositions and articles are biodegradable and will break down naturally over time, without causing harm to the environment.

A first aspect of the present disclosure is directed to a biodegradable composition, suitable for use in packaging, containing an Ulva polysaccharide, a nanomaterial, a non-Ulva biomass, and a non-phthalate plasticizer. In some embodiments, the Ulva polysaccharide is substantially purified. In some embodiments, the substantially purified Ulva polysaccharide is ulvan, cellulose, starch, or a combination of two or more thereof.

In some embodiments, the Ulva polysaccharide is chemically modified. In some embodiments, the modified Ulva polysaccharide is present in the composition in the form of a hydrogel. In some embodiments, the modified Ulva polysaccharide is crosslinked.

In some embodiments, the non-phthalate plasticizer is a biological plasticizer, also referred herein as bio-based plasticizer.

Nanomaterials may be biological, natural (inorganic), synthetic nanomaterials, or a combination of two or more thereof. Like the Ulva polysaccharides, biological nanomaterials, also referred herein as bionanomaterials and bio-nano, are readily obtainable from renewable biological or biomass sources such as plants, bacteria, fungi, and algae.

In some embodiments, the Ulva polysaccharide is coated onto the nanomaterial.

In some embodiments, the biodegradable composition further contains a propellent.

Another aspect of the present disclosure is directed to a biodegradable article, having a desired shape and size, and constructed from the biodegradable composition. In some embodiments, the article is a film or coating. In some embodiments, the article is a packaging material. In some embodiments, the article is a package.

In some embodiments, a label is affixed to or otherwise disposed on the article. The label may contain information relating the article, the process in which the article was created, and/or the company which produced the article. In some embodiments, the information on the label relates to quantifiable units of carbon capture, reduced greenhouse gas (GHG) emissions, reduced GHG emissions by scope categories (i.e., scopes 1-4), energy consumption, waste effluents, downstream impacts of the article, certification marks (e.g., a Biodegradable Products Institute (BPI) certification), Ecolabels (e.g., an Eco/Green label and/or an eco-label), listing of American Society for Testing and Materials (ASTM) standards for materials and compostability of the article (e.g., ASTM D6400), reduced water usage, reduced transport costs, specific energy sources, ecological co-benefits, carbon accounting protocol type, and codes for tracking this information.

Yet another aspect of the present disclosure is directed to a method of forming a biodegradable article. The method entails preparing the biodegradable composition and forming the article into a desired shape and size.

In addition to the forementioned advantages, the presence of the Ulva polysaccharide may further enhance one or more properties of an article, such as moisture content, water vapor permeability, and tensile strength.

### BRIEF DESCRIPTION OF THE DRAWINGS

FIG. 1 is a schematic illustrating two methods of ulvan extraction and purification.

FIG. 2 is a set of chemical structures illustrating aldobiuronic acids and ulvanobioses disaccharide repeating units of ulvan.

### DETAILED DESCRIPTION OF THE DISCLOSURE

Unless defined otherwise, all technical and scientific terms used herein have the same meaning as is commonly understood by one of skill in the art to which the subject matter herein belongs. As used in the specification and the appended claims, unless specified to the contrary, the following terms have the meaning indicated to facilitate the understanding of the present disclosure.

As used in the description and the appended claims, the singular forms “a”, “an”, and “the” mean “one or more” and therefore include plural referents unless the context clearly dictates otherwise. Thus, for example, reference to “a composition” includes mixtures of two or more such compositions, reference to “an extract” includes mixtures of two or more such extract, and the like.

Unless stated otherwise, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term “about.”

The term “substantially purified” as used herein refers to a component in the biodegradable composition that may be substantially or essentially free of other components which normally accompany or interact with the ingredient in its natural state, or prior to purification. By way of example, a Ulva polysaccharide may be “substantially purified” when the preparation of the component of interest contains less than about 30%, less than about 25%, less than about 20%, less than about 15%, less than about 10%, less than about 5%, less than about 4%, less than about 3%, less than about 2%, or less than about 1% (by dry weight) of other components (e.g., Ulva components other than polysaccharides). Thus, a “substantially purified” component (e.g., Ulva polysaccharide) may have a purity level of about 70%, about 75%, about 80%, about 85%, about 90%, about 95%, about 96%, about 97%, about 98%, about 99% or greater.

The transitional term “comprising,” which is synonymous with “including,” “containing,” or “characterized by,” is inclusive or open-ended and does not exclude additional, unrecited elements or method steps. By contrast, the transitional phrase “consisting of” excludes any element or method step not specified in the claim (or the specific element or method step with which the phrase “consisting of” is associated). The transitional phrase “consisting essentially of” limits the scope of a claim to the specified elements and method or steps and “unrecited elements and method steps that do not materially affect the basic and novel characteristic(s)” of the claimed disclosure.

### Biodegradable Compositions

In one aspect, the disclosure provides a biodegradable composition (also referred to herein as a “composite”) containing an Ulva polysaccharide, a nanomaterial, a non-Ulva biomass, and a non-phthalate plasticizer. The term “composite” as used herein to refers to products made from two or more different components which provides a designed solution that surpasses the performance of each of the starting materials alone.

The term “biodegradable” as used herein refers to a material, including a single-use material, that can be broken down (decomposed) by the environment, e.g., by, the action of microorganisms and exposure to other environmental conditions. No special conditions are required for decomposition of a biodegradable material. No segregation or isolation of the biodegradable material from other waster products is required for decomposition.

Biodegradable compositions and articles produced therefrom may be composted, i.e., allowed to undergo aerobic decomposition, which produces organic materials and carbon dioxide (as opposed to methane). The term “compostable” as used herein refers to a material that may disintegrate into natural elements in a compost environment. Typically, compostable indicates the material complies with ASTM D6400, ASTM D6868, and/or ISO 17088 standards. A compostable material typically requires segregation from other water materials.

Ulva (Phylum Chlorophyta, Class Ulvophyceae, Order Ulvales, Family Ulvaceae) is a genus of green algae widely distributed throughout the world. Ulva species are primarily marine taxa found in saline and salty waters, but some Ulva species can also proliferate in freshwater habitats. Ulva species are commonly referred to as sea lettuce.

The source of the Ulva polysaccharide is not critical. Any Ulva species may be used as a source for an Ulva polysaccharide. In some embodiments, the Ulva polysaccharide is extracted from Ulva lactuca, U. fasciata, U. ohnoi, U. prolifera, U. armoricans, U. australis, U. rigida, U. linza, U reticulata, U. ralfsii, U. compressa, U. pertusa, U. intestinalis, U. flexuosa, U. californica, U. curvata, U. digitata, U. clathrate, U. scandinavica, U. adhaerens, U. spathulate, or a combination of two or more thereof. In some embodiments, the Ulva polysaccharide is produced from U. ohnoi, U. australis, U. ralfsii, or a combination of two or more thereof.

The term “Ulva polysaccharide” is used herein to broadly refer to polysaccharides that have a molecular structure consisting chiefly or entirely of monosaccharide units bonded together that originate from Ulva. The Ulva polysaccharides include ulvan, starch, cellulose, and combinations of two or more thereof. The Ulva polysaccharide may be produced by subjecting Ulva to pulverization, grinding, drying, digestion, extraction, purification, or a combination of two or more techniques thereof.

The term “extract” as used herein refers to the diverse fractions that are extracted, harvested, and processed from fresh Ulva, including polysaccharides. See, U.S. Patent Application Publication No. 2022/0204730. In some embodiments, the Ulva polysaccharide is substantially purified ulvan.

Ulvans are cell wall polysaccharides that contribute about 10% to about 45% dry weight of the Ulva biomass. The quantitative yield and the quality of ulvan can vary significantly depending on the source of the Ulva species, cultivation technique (wild or cultivated), pre-extraction process, extraction process, purification process, location, and storage. In some embodiments, the Ulva extract contains a dried and pulverized Ulva species with about 20% to about 35% ulvan.

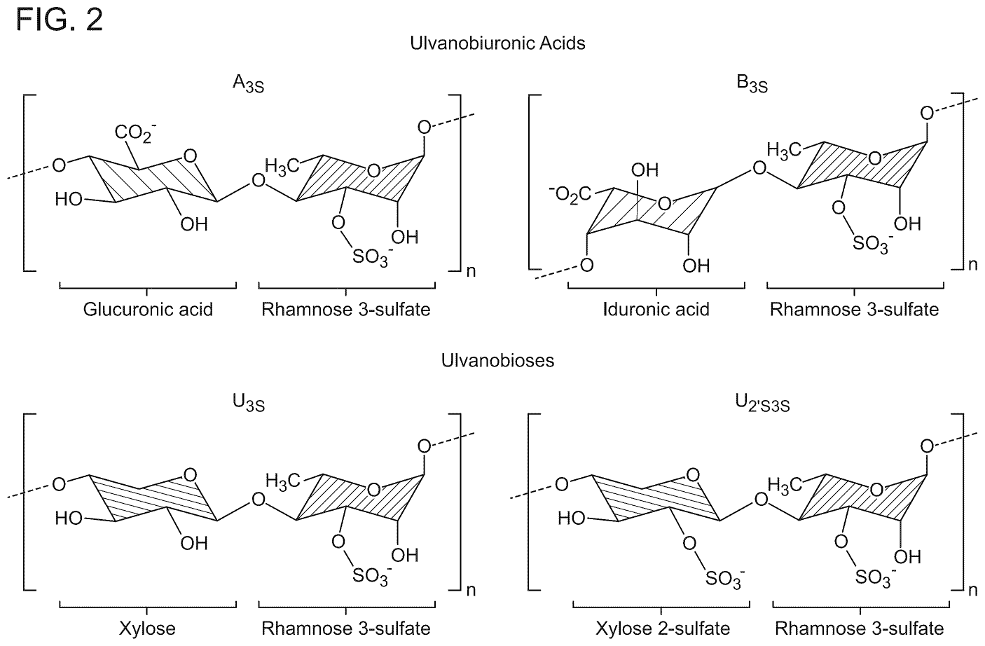

Ulvans are polyanionic sulfated heteropolysaccharides that contain rhamnose, xylose, glucuronic acid and iduronic acid, with the main repeating units of β-D-glucuronic acid (1→4)-α-L-rhamnose-3-sulfate and α-L-iduronic acid (1→4)-α-L-rhamnose-3-sulfate. The iduronic acid or glucuronic acid components may instead be a xylose unit (sulfated or non-sulfated) forming the characteristic monomers β-D-xylose (1→4)-α-L-rhamnose-3-sulfate and β-D-xylose-2-sulfate (1→4)-α-L-rhamnose-3-sulfate. Trace amounts of galactose and glucose can be found in ulvan. The chemical structures of the major and minor disaccharide repeating units are illustrated in FIG. 2. See, e.g., Tziveleka et al., Carbohydr. Polym. 218:355-370 (2019); Lakshmi et al., Biomolecules 10(7):991-20 (2020); Wahlström et al., Carbohydr Polym. 233:115852-9 (2020); Amor et al., Biomass Conversion and Biorefinery 13:3975-3985 (2023) and U.S. Patent Application Publication No. 2022/0289999.

Once the mole ratio of constituent sugars in ulvan from a particular source and batch is defined, the molecular structure can be altered through depolymerization and removal or addition of functional groups (e.g., sulfate esters). Altering the molecular structure enables optimizing and changing the functional properties of ulvan for a given composition and the article to which it is incorporated. In this regard, ulvan molecular weights (about 1 kDa to about 2000 kDa) and degree of sulfation (about 2.3% to about 40%) vary widely and have a large influence on physicochemical properties and biological activities. Depolymerization can be achieved through chemical and enzymatic hydrolysis with ulvan lyases. The degree of sulfation can be altered by addition of sulfate esters or removal of sulfate esters by solvolysis of the ulvan pyridinium salt or through base hydrolysis. Charge can be altered through manipulation of the degree of sulfation and by derivatization of the carboxylic acid groups (e.g., esterification and amide formation). Both the charge and the mole ratio of constituent sugars can be varied by reduction of glucuronic acid and iduronic acid to glucose and idose. Chemically modified Ulvans that may be useful in the practice of the present disclosure are described, for example, in U.S. Patent Application Publication No. 2009/0299053.

Ulvans isolated from blade Ulva species have been reported to have a higher sulfate ester content (and therefore higher overall sulfate content) than filamentous Ulva species. The degree of sulfation in ulvan has previously been correlated with anticoagulant, antihyperlipidemic and anti-viral activity. Therefore, ulvans isolated from blade and filamentous Ulva species may have different bioactivities. The degree of sulfation is also likely to affect the solution properties of ulvan (e.g., rheology). As the degree of sulfation of ulvan increases, the viscosity of a ulvan-containing composition also increases. Biodegradable resin compositions with increased viscosity may enhance the workability of the article during forming by increasing its viscosity and improving the resin's ability to mix, and form (i.e., increased workability). Therefore, Ulva polysaccharides sourced from a blade Ulva species may have higher sulfate content than Ulva polysaccharides sourced from filamentous Ulva species and may be used in biodegradable resin compositions where increased viscosity and workability are advantageous.

The constituent sugar compositions of purified polysaccharides (e.g., ulvans) may be determined by High Performance Anion-Exchange Chromatography (HPAEC) after hydrolysis of the polysaccharides to monosaccharides. The sugars identified from their elution times relative to a standard sugar mix (L-fucose, L-rhamnose, L-arabinose, D-galactose, D-glucose, D-glucosamine, D-mannose, D-xylose, D-ribose, D-galacturonic acid, D-glucuronic acid, and L-iduronic acid), quantified from response calibration curves of each sugar and expressed as μg of the anhydro-sugar (the form of sugar present in a polysaccharide) per mg of sample, the normalized mol % of each anhydro-sugar may also be calculated.

Ulvan from the blade species U. rigida has been reported to have the highest iduronic acid content at 18 mol %. Ulvans isolated from U. flexuosa and U. prolifera have been reported to have high proportions of rhamnose (56 and 60 mol %, respectively), and ulvans from U. ralfsii have been reported to contain high proportions of galactose (from about 10 to about 16 mol %). Despite the high proportions of galactose found in ulvans from filamentous U. ralfsii, the Rha to [GlcA+IdoA+Xyl] ratio for both species has been reported at 0.9:1.

The molecular weight distribution of ulvans may be determined using size-exclusion chromatography coupled with multi-angle laser light scattering (SEC-MALLS). For example, in a study where ulvans were extracted from a single source of U. ohnoi (a blade species) using different biorefinery pre-treatments and extractants, the average molecular weight of the isolated ulvan varied from about 10.5 to about 312 kDa. Other studies have reported widely varying molecular weights for ulvans, e.g., about 2000 kDa from blade U. armoricans, about 194 kDa from filamentous U. intestinalis, and about 1,218 kDa from filamentous U. prolifera.

The Ulvan may have a molecular weight in the range of about 5 kDa to about 2,500 kDa and a degree of sulfation of about 9% to about 35%. In some embodiments, the sugar composition of ulvan is between about 5 to about 92.2 mol % rhamnose, about 2.6 to about 52 mol % glucuronic acid, about 0.6 to about 15.3 mol % iduronic acid, and about 0 to about 38 mol % xylose. In some embodiments, the sugar composition is about 45 mol % rhamnose, about 22.5 mol % glucuronic acid, about 5 mol % iduronic acid, and about 9.6 mol % xylose.

In some embodiments, the sugar composition of ulvan is from about 41 to about 53.1 mol % rhamnose, about 27 to about 30 mol % glucuronic acid, about 7.4 to about 10.1 mol % iduronic acid, and about 5.3 to about 5.7 mol % xylose.

Starch is a polysaccharide that serves as an energy storage molecule in plants. It consists of glucose units and is commonly found in crops such as corn, potatoes, and wheat. Starch is biodegradable and is broken down by bacterial, fungal, and animal amylases. The starch content in corn can range from about 70% to about 72% of the dry weight. On average, potatoes typically contain about 15% to about 20% starch by dry weight. On average, wheat grains contain about 65% to about 75% starch by dry weight. Ulva may contain up to about 30% of starch by dry weight. The thermo-chemical properties of Ulva starch are described in, for example, Prabhu et al., Algal Research 37:215-227 (2019).

The main component of the Ulva cell-wall is cellulose. Since it contains less lignin than terrestrial plants, less stringent conditions may be used to obtain substantially purified cellulose from Ulva, leading to less degradation of the purified cellulose (Halib et al., Materials (Basel). 10(8): 977 (2017)). Ulva may contain up to about 30% of cellulose by dry weight. See, Wahlström et al., Cellulose 27:3707-3725 (2020), and El-Sheekh et al., Sci. Rep. 13(1):10188 (2023).

Polymers in plastic undergo a transition from glassy to rubbery state at the glass transition temperature (Tg). The Tg marks a region of dramatic changes in the physical and mechanical properties of the resulting article. In some embodiments, the Ulva polysaccharide has a glass transition temperature (Tg) ranging from about 110 to about 150° C. The Tg of the Ulva polysaccharide may be adjusted to meet the needs at hand. In some embodiments, the Ulva polysaccharide has a Tg ranging from about 110 to about 125° C. In some embodiments, the Ulva polysaccharide has a Tg of about 120° C.

In some embodiments, the Ulva polysaccharide is extracted by enzyme-assisted extraction, acid extraction, microwave-assisted extraction, ultrasound-assisted extraction, ultrasound- and microwave-assisted extraction, supercritical water extraction, or a combination of a two or more thereof. Filtration, precipitation, purification, drying, or a combination of a two or more thereof may follow extraction.

Enzyme-assisted extraction uses enzymes to break down the cell wall of Ulva, facilitating the release of Ulva polysaccharides (e.g., ulvan). Enzymes such as cellulases, pectinases, and protease may be employed to enhance the extraction efficiency of some Ulva polysaccharides (e.g., ulvan and starch). Cellulose may be added in some enzyme-assisted extractions. Heating may also be employed, however, the temperatures required for use in enzyme-assisted extraction are not typically high enough to destroy polymers or other desired molecules. This extraction method reduces the need for harsh chemicals and high temperatures, making it more eco-friendly. See, Lahaye and Axelos, Carbohydrate Polymers, 22(4):261-265, Guidara et al., Int. J. Biol. Macromol. 150:714-726 (2020), and Guidara et al., Carbohydr. Polym. 253:117283 (2021).

Acid extraction uses an acidic solution to break down the components (e.g., cell wall) of Ulva, releasing Ulva polysaccharides. Acids such as chlorhydric acid solution (pH about 1.5 to about 2) may be employed to extract Ulva polysaccharides from Ulva. Stirring and/or heat may be used to facilitate extraction. See, Yaich et al., Food Hydrocoll. 40:53-63 (2014), Blanco-Pascual et al., Food Hydrocolloids, 37:100-110 (2014), Guidara et al., Int. J. Biol. Macromol. 150:714-726 (2020).

Microwave assisted extraction involves microwave irradiation to extract Ulva polysaccharides from Ulva. This method uses the heating effect of microwaves, which enhances the diffusion of ulvan from the algal matrix into the solvent. Microwave-assisted extraction has been found to be faster and more efficient compared to other extraction methods.

Supercritical (SC) fluid extraction involves the use of supercritical fluids, such as supercritical carbon dioxide (SC-CO₂) as an alternative solvent for Ulva polysaccharide (e.g., ulvan) extraction. SC-CO₂ has excellent solvent properties, and its low critical temperature allows for gentle extraction conditions. This extraction method offers high selectivity and avoids the use of organic solvents, making it a greener extraction approach.

Following extraction, the Ulva polysaccharide may be filtered and/or precipitated. The liquid mixture containing the Ulva polysaccharide that results from extraction may be separated from the solid residue using standard filtration methods, such as vacuum filtration or centrifugation. Filtration may assist the removal of any remaining debris or insoluble components.

The Ulva polysaccharide resulting from extraction is often dissolved in a liquid (solution) and needs to be concentrated. Adding a suitable precipitant, such as ethanol, acetone, or calcium chloride, to the solution causes Ulva polysaccharide to separate from the solution and form a precipitate.

The Ulva polysaccharide may then be substantially purified to remove impurities and other unwanted compounds. Purification techniques include, for example, dialysis, ion exchange chromatography, and ultrafiltration. Ultrafiltration purification utilizes a membrane with a specific molecular weight cutoff, allowing Ulva biomolecules under a specific molecular weight to pass through the membrane and blocking impurities above that molecular weight or vice versa. In some embodiments, the Ulva polysaccharide is purified through a 10 kDa ultrafiltration membrane. See, Yaich et al., Food Hydrocoll. 40:53-63 (2014), Abdelmalek et al., Int. J. Biol. Macromol. 72:1143-1151 (2015), and Guidara et al., Int. J. Biol. Macromol. 150:714-726 (2020).

The term “substantially purified” as used herein in the context of Ulva polysaccharide refers to an Ulva polysaccharide that may be substantially or essentially free of other components which normally accompany or interact with the Ulva polysaccharide in its natural state, or prior to purification. In some embodiments, a substantially purified Ulva polysaccharide is at least about 90%, about 95%, about 96%, about 97%, about 98%, or about 99% pure.

The Ulva polysaccharide may be dried. After extraction, the Ulva polysaccharide is typically in a wet or semi-wet state. Drying the Ulva polysaccharide may be employed to obtain a dry powder form that may be suitable for inclusion in a biodegradable composition. Techniques employed for drying may include air drying, freeze drying, or spray drying.

Examples of macroalgae polysaccharide extraction, filtration, precipitation, purification, and drying (dewatering) techniques are described in Smith et al., Northwest Science 42:165-171 (1968), and Honeycutt, Biotechnology and Bioengineering Symp. 13:567-575 (1983), Moulton et al., Hydrobiologia 204/205:401-408 (1990), Borowitzka et al., Bulletin of Marine Science 47:244-252 (1990), Rose et al., Water Science and Technology 25:319-327 (1992), Ray and Lahaye, Carbohydr. Res. 274:251-261 (1995), Lahaye et al., Hydrobiologia 326-327(1):473-480 (1996), Aresta et al., Full Process. Technol. 86:1679-1693 (2005), Valderrama et al., FAO Fisheries and Aquaculture Technical Paper 580 (2014), Fudholi et al., Energy Build. 68:121-129 (2014), and U.S. Pat. Nos. 6,524,486, 8,507,253, 8,518,132, 9,248,590, 9,499,941, 10,336,965, 10,421,216, and 11,039,622, and U.S. Patent Application Publication Nos. 2004/0121447, 2011/0253646, 2011/0258915, 2020/0045981, and 2021/0307272.

Ulvan may be extracted from an Ulva species via numerous means known in the art, e.g., hot water, acid extraction, alkaline extraction, ultrasound extraction, microwave extraction, enzyme extraction, and pulse-field extraction. Additional ulvan extraction methods are described, for example, in Lahaye and Robic, Biomacromolecules 8(6):1765-74 (2007), Chiellini et al., Biomacromolecules 9(3):1007-13 (2008), Wahlström et al., Cellulose 27:3707-3725 (2020), Prabhu et al., Algal Research 37:215-227 (2019), El-Sheekh et al., Sci. Rep. 13(1):10188 pp1-12 (2023); U.S. Pat. No. 10,549,997, and U.S. Patent Application Publication Nos. 2009/0299053, 2022/0204730, and 2022/0289999.

The yield and quality of ulvan produced may vary based on the extraction method. The choice of extraction method is generally based around the physicochemical properties of the ulvan and its specific interactions with other components of the algal cell wall (e.g., starch, cellulose, xyloglucan and glucuronan) when the Ulva biomass is contacted with the solvent.

Hot water or aqueous organic solvents are the most common and conventional methods for extracting water-soluble polysaccharides (e.g., ulvan) from Ulva. These methods provide ulvan that contains glucuronic acid, glucose, arabinose, and xylose, with an average ulvan yield of about 25 to about 40%. Another extraction method involves adding about 0.05 to about 1% hydrochloric acid (pH 1.5 to 2), with an average ulvan yield of about 15 to about 45%. Enzyme extraction utilizes onozula RS, pectinase macerozyme, α-amylase, and proteinase K, which are suspended in the buffer. The ulvan yield with enzyme extraction is about 15 to about 47%. In addition to the three widely used methods, other methods include multilevel extraction, using water followed by NaCO₃ and NaOH solvents, with about 3.14 to about 6.50% yield. There is also a sequential extraction method that involves acidic solutions and ammonium oxalate with an average ulvan yield.

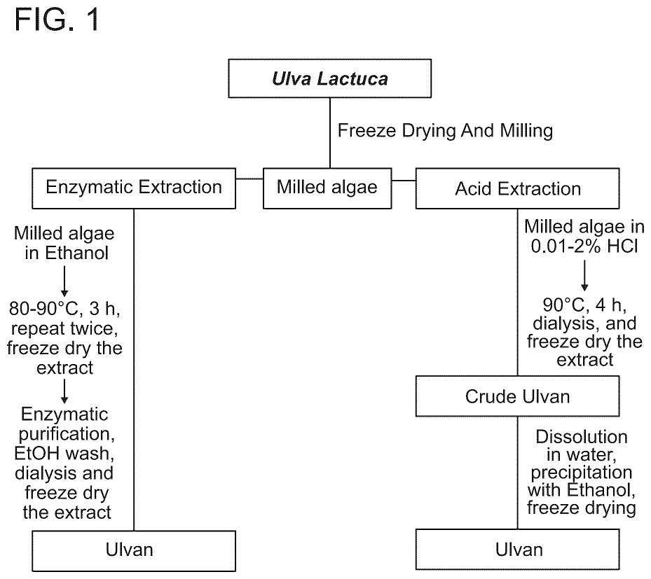

Concentration, solvent pH, extraction temperature, and duration may be varied to achieve the desired results, e.g., in terms of yield and quality of extraction (e.g., purity and molecular integrity). FIG. 1 schematically illustrates two representative ulvan extraction and purification methods from Ulva lactuca conducted at a temperature of about 80 to about 90° C., a pH of about 2 to about 4.5, and a duration of about 1 to about 3 h, and that result in high extraction yield, high selectivity, and low degradation.

In some embodiments, purification or fractionation is conducted by anion exchange chromatography (e.g., an AEC-Q-Sepharose column). The anion exchange chromatography is coupled with a single wavelength (280 nm) UV detector and a fraction collector. A chromatogram may be produced by colorimetric analysis of the collected fractions for uronic acid using glucuronic acid as a standard. Appropriate fractions may then be pooled and freeze-dried to yield substantially purified ulvan.

The amount of the Ulva polysaccharide in the biodegradable composition generally ranges from about 0.1 to about 5%, and in some embodiments, from about 0.5 to about 5%, based on the total weight of the composition.

### Chemical Modifications

Ulva polysaccharides have a high number of functional groups that can be easily modified or tailored, post-extraction and purification, to provide desirable functional properties. Possible chemical modifications to Ulva polysaccharides include modification to a reactive chemical moiety, e.g., a hydroxyl group, an amino group, an ε-amino group, a carboxylic acid group, a carboxylate group, a carboxamide group, a cationic group, an anionic group, or a combination of two or more thereof.

In some embodiments, the Ulva polysaccharide is crosslinked. Crosslinking is the process of connecting individual polymer chains by covalent or noncovalent bonds to form a three-dimensional network. Chemical crosslinking involves forming covalent bonds between polymers by irradiation, sulfur vulcanization, or chemical reactions. Physical crosslinking involves forming noncovalent bonds (e.g., ionic interactions including hydrogen bonds or hydrophobic interactions).

Crosslinking may entail the use of symmetrical bifunctional compounds with reactive groups with specificity for functional groups present on the Ulva polysaccharide. In some embodiments, the Ulva polysaccharide is crossed linked by reacting the Ulva polysaccharide with divalent cations, photosensitive molecules, microwave electromagnetic radiation, biological solvents, 1-Ethyl-3-(3-dimethylaminopropyl)carbodiimide (EDC), glyoxal, glutaraldehyde, genipin, dextran-tyramine, PEG, thiolated PEG, hyaluronic acid-tyramine, a transglutaminase, a peroxidase, a tyrosinase, a phosphopantetheinyl transferase, a lysyl oxidase, a plasma amine oxidase, a phosphatase, or a combination of a two or more thereof.

Ionic crosslinking may involve divalent cations such as calcium ions (Ca²⁺) to crosslink Ulva polysaccharides. The positively charged ions may interact with negatively charged sulfate groups present in Ulva polysaccharides (e.g., ulvan), leading to three-dimensional network formation. In some embodiments, the three-dimensional network is in the form of a gel. Ionic crosslinking is simple and environmentally benign, as it does not utilize toxic crosslinking agents (e.g., short chain aldehydes).

Photochemical crosslinking involves light-activated crosslinking agents to initiate polysaccharide gelation. Photochemical crosslinking agents include the photosensitive molecules riboflavin and rose bengal, which generate reactive oxygen species upon exposure to light. The produced reactive species may induce crosslinking reactions in Ulva polysaccharides. This method offers precise control over gelation by adjusting the light intensity and duration. Ultra-violet (UV)-assisted crosslinking is a subset of photochemical crosslinking and involves applying UV irradiation to facilitate the crosslinking of Ulva polysaccharides. UV crosslinking is not a heat-sensitive process and UV crosslinking has the advantages of a high production rate, continuous production, small fundamental investment, low raw material cost, and low energy consumption. Light-activated crosslinking agents are known in the art and include dipropylene glycol diacrylate (DPGDA), trimethylolpropane triacrylate (TMPTA), and alkoxylated pentaerythritol tetra acrylate (e.g., Photomer 4172F).

Microwave-assisted crosslinking involves applying microwave irradiation to facilitate the crosslinking of Ulva polysaccharides. This method offers rapid and efficient gelation compared to traditional heating methods. It can be a greener alternative as it reduces energy consumption, processing time, and does not utilize toxic crosslinking agents.

Freeze-thawing crosslinking involves subjecting Ulva polysaccharide solutions to multiple freeze-thaw cycles, where the formation of ice crystals physically crosslinks the Ulva polysaccharides. The subsequent thawing process may result in the formation of a hydrogel network.

Crosslinking using green solvents replaces conventional organic solvents with eco-friendly alternatives. For example, water-based solvents or bio-based solvents obtained from renewable resources can be used to dissolve Ulva polysaccharides and facilitate crosslinking. This reduces the environmental impact associated with the use of toxic solvents.

### Hydrogels

In some embodiments, the biodegradable composition containing the Ulva polysaccharide is in the form of a hydrogel. Hydrogels are three-dimensional polymeric networks that can absorb fluid and swell. Hydrogels are maintained through chemical bonds between polymers and absorb water molecules by the presence of hydrophilic groups. Moisture absorption by articles formed with a hydrogel-containing composition improve shelf life by reducing moisture that would otherwise lead to a reduction in flavor quality and microbial growth.

In some embodiments, an Ulva polysaccharide hydrogel is formed with borate and calcium. In some embodiments, the biodegradable composition containing the Ulva polysaccharide in the form of a hydrogel contains about 1 percent by weight (wt %) or more Ulva polysaccharide, the borate is about 4.5 mM and the calcium is about 2 M. Borate-Ulva polysaccharide complexes create intermolecular linkages stabilized by the calcium ions to form the hydrogel. In some embodiments, the hydrogel composition contains about 1.6 wt % in deionized water. In these embodiments, boric acid and calcium ions may be added to the hydrogel. In these embodiments, the pH may be adjusted to about 7.5.

In some embodiments, the Ulva polysaccharide may be combined with the non-Ulva biomass to form a hydrogel. In some embodiments, the Ulva polysaccharide is combined with biomass containing chitosan or substantially purified chitosan. In some embodiments, the hydrogel composition contains 1.5 wt % Ulva polysaccharide (e.g., ulvan), 1.5 wt % chitosan, and acetic acid. The hydrogel may be formed over time, e.g., stored at 20° C. for 20 h and, optionally, also stored in water for 3 h to remove low molecular weight salts in the gel, and further optionally, freeze-dried.

Hydrogels form when the polymers within a composition are crosslinked. The crosslinking interactions can be physical, chemical, or both. Crosslinking can be formed by simple mixing, solution casting, bulk polymerization, free radical polymerization, UV and gamma irradiation, and interpenetrating network formation method. See, Bashir et al., Polymers (Basel). 12(11):2702 1-60 (2020). In some embodiments, the Ulva polysaccharide is chemically modified. In some embodiments, the Ulva polysaccharide is modified with acetic anhydride to form amphiphilic polymers (e.g., acetylated ulvan) which then interact with each other to form a hydrogel composition. In some embodiments, the acetylated Ulva polysaccharide is combined with Curcumin. The acetylated Ulva polysaccharide and Curcumin interacts to form an Ulva polysaccharide-Curcumin hydrogel. In some embodiments, the Ulva polysaccharide is modified with poly(N-isopropylacrylamide). The 1 poly(N-isopropylacrylamide)-modified Ulva polysaccharide interacts with itself to form a hydrogel. In some embodiments, the Ulva polysaccharide is modified by tyramine and combined with a horseradish peroxidase enzyme, which in turn catalyzes hydrogel formation through the covalent coupling the grafted phenols of the tyramine. Enzymatic crosslinking presents a straightforward, rapid, and clean method as compared with chemical crosslinking.

In some embodiments, the Ulva polysaccharide is modified with glycidyl methacrylate, further bound to methacrylic anhydride, through a reaction with chondroitin sulfate as a substrate, and is UV crosslinked to form a hydrogel.

Additional polysaccharide hydrogel formation methods are described, for example, in Haug, Acta Chem. Scand. B. 30(6):562-566 (1976), Kanno et al., Journal of Sustainable Development 5(4):38-45 (2012), Toskas et al., Carbohydr. Polym. 89:997-1002 (2012), Dash et al., Carbohydr. Polym. 182:254-264 (2018), Bang et al., Bull Mater Sci 42:1-7 (2019), Morelli et al., Carbohydr. Polym. 136:1108-1117 (2016), Morelli, Macromol. Chem. Phys., 217:581-590 (2016), and Morelli and Chiellini, Macromol. Chem. Phys., 211:821-832 (2010).

### Nanomaterials

The disclosed compositions also contain a nanomaterial. Representative nanomaterials that may be suitable for use in the present biodegradable composition include, for example, biological nanomaterials, natural nanomaterials (including carbon nanomaterials, organic nanomaterials, or inorganic nanomaterials), synthetic nanomaterials, and combinations of two or more thereof. In some embodiments, at least a portion of the Ulva polysaccharide in the composition is coated onto the nanomaterial. In some embodiments, at least a portion of the nanomaterial in the composition is coated onto the Ulva polysaccharide. Nanomaterials, representative types of which includes nanoparticles, nanotubes, nanofibers, micelles, and fibrils, improve barrier and thermal properties of the article (e.g., melting point, glass transition temperature, surface wettability, and hydrophobicity).

Biological nanomaterials, also known as bionanomaterials and bio-nano, are a type of renewable nanoparticle obtained from a living organism (e.g., as an extract) or as a byproduct of a living organism such as plants, bacteria, fungi, or algae, and are biodegradable, which reduces the amount of waste and pollutants, thereby reducing the carbon footprint of the article to which they are incorporated.

The term “renewable” as used herein refers to a material that can be produced or is derivable from a natural source which is periodically (e.g., annually, or perennially) replenished through the actions of plants of terrestrial, aquatic, or oceanic ecosystems (e.g., agricultural crops, edible and non-edible grasses, forest products, seaweed, or algae), or microorganisms (e.g., bacteria, fungi, or yeast). Renewable biological nanomaterials often possess unique properties and can be integrated into various materials, including algal polysaccharide, through coating and other techniques. These bionanomaterials may increase the functional properties of the end product article, including increased barrier function, melting points, and glass transition temperatures. Furthermore, biological nanomaterials have low toxicity, reducing the risk of harm to both humans and the environment. See, e.g., Krishnaraj et al., Spectrochim. Acta A. Mol. Biomol. Spectrosc. 93:95-99 (2012); Prakash et al., Colloids Surf B Biointerfaces. 108:255-259 (2013); Sreekanth et al., J. Photochem. Photobiol. B 141:100-105 (2014); Ravikumar et al., J. Nanosci. Nanotechnol. 15(12):9617-9623 (2015); Chokshi et al., RSC Adv. 6:72269-72274 (2016); Dhayalan et al., Nat. Prod. Res. 31(4):465-468 (2017); Stan et al., Acta Metallurgica Sinica Engl. 29:228-236 (2016); Stan et al., Process Saf. Environ. 107:357-372 (2017); and Otunola et al., Pharmacogn. Mag. 13(Suppl 2):S201-S208 (2017).

Biological nanomaterials may be produced from polypeptides, polysaccharides, glycolipids, and combinations thereof. Biological nanomaterials produced from polypeptides are advantageous in their biodegradability, low toxicity, non-antigenicity, high stability, and binding capacity. Biological nanomaterials produced from polypeptides may bind water molecules in a composition and alter the composition's viscosity. Polypeptides used to produce biological nanomaterials include collagen, elastin, fibronectin, and soy protein. See, e.g., Chen and Remondetto, Trends Food Sci. Technol. 17:272-283 (2006); Elzoghby et al., J. Control. Release 153(3): 206-216 (2011); Elzoghby et al., J. Control. Release 157(2):168-182 (2012); Gomes and Sobral, Molecules 27(1):60-30 (2021); McManus et al., Curr. Opin. Colloid Interface Sci. 22:73-79 (2016); Wan et al., Food Funct. 6:2876-2889 (2015); Oliveira et al., Food Res. Int. 102:759-767 (2017); Xue et al., Food Hydrocoll. 96:178-189 (2019); Keppler et al., Trends Food Sci. Technol. 101:38-49 (2020); Sun et al., Front. Bioeng. Biotechnol. 8:295 (2020).

Representative examples of polysaccharides used to produce biological nanomaterials include carrageenan, propylene glycol alginate, carboxymethylcellulose, and xanthan gum. See, e.g., Chen et al., Food Hydrocoll. 99:105334-10 (2020); Wei et al., Food Hydrocoll. 95:336-348 (2019); Liu et al., Food Hydrocoll. 79:450-461 (2018); Xuemei et al., Food Funct. 11:2380-2394 (2020); Aceituno-Medina et al., J. Funct. Foods. 12:332-341 (2015).

Biological nanomaterials may also be produced directly by a living organism, including bacteria (e.g., Pseudomonas aeruginosa, Thiobacillus, Serratia, and Stenotrophomonas species), fungi, or yeast (e.g., Saccharomyces cerevisiae), and subsequently purified from the living organism. See, e.g., Janssen et al., Colloid Surf. B. 6:115-129 (1996); Stefess et al., Appl. Microbiol. Biot. 45:169-175 (1996); Malhotra et al., Bioresour. Technol. 142:727-731 (2013); Mishra et al., PLOS One 9(5):e97881-11 (2014); Mishra et al., Sci Rep. 7:45154-15 (2017); Singh et al., Proc. Natl. Acad. Sci. India Sect. B. 84:331-336 (2014). Biological nanomaterials (i.e., bio-nano) are distinct from natural (inorganic) nanomaterials and synthetic nanomaterials, as described below.

Natural nanomaterials are obtainable from natural inorganic processes including volcanic activity, combustion, precipitation, and oxidation. Sources of natural nanomaterials include surface fresh water, sea water, volcanic eruptions, combustion exhaust, atmospheric particulate matter, ore deposits, umber, and mineral wells. Representative examples of natural nanomaterials include nanoscopic ash, nanoscopic soot (carbon), silicate nanoparticles, clay (e.g., montmorillonite, sodium montmorillonite, montmorillonite complexed with copper oxide, bentonite, kaolinite, hectorite, and halloysite (e.g., halloysite nanotubes), iron nanoparticles, calcium carbonate nanoparticles, alumina nanoparticles, and bassanite (calcium sulfate) nanoparticles. See, e.g., Rauch et al., Environ. Sci. Technol. 39(21):8156-8162 (2005); Wu et al., Sci. Rep. 6:28817-11 (2016); Strambeanu et al., Nanoparticles' Promises and Risks: Characterization, Manipulation, and Potential Hazards to Humanity and the Environment. Springer International Publishing, p. 9-19 (2015) Cham, Switzerland; Guo et al., J. Mater. Chem. 1:274-42 (2013); Stawski et al., Nat. Commun. 7:11177-9 (2016); Faulstich et al., Int. Biodeterior. Biodegrad. 119:678-686 (2017); Hough et al., Ore Geol. Rev. 42:55-61 (2011); McGillicuddy et al., Sci. Total Environ. 575:231-246 (2017); and Zhang et al., Water Res. 88:403-427 (2016).

In some embodiments, the natural nanomaterial is a nanomaterial produced from combustion waste. Natural nanomaterials produced from combustion and waste products thereof that may be suitable for use in the biodegradable compositions are described in U.S. Pat. No. 7,157,066, 7,279,137, 7,335,344, 9,051,185, 9,409,779, and 9,738,524, and U.S. Patent Application Publication Nos. 2005/0163696, and 2007/0183959.

Synthetic nanomaterials may be produced from metals, metal oxides (e.g., zinc oxide, magnesium oxide, cerium oxide), ceramics, synthetic polymers, carbon, and dendrimers (branched, synthetic polymers). In some embodiments, the synthetic nanomaterials are metal nanoparticles, metal oxide nanoparticles, ceramic nanoparticles, synthetic polymer nanoparticles, dendrimer nanoparticles, or a combination of two or more thereof. In some embodiments, the synthetic nanomaterials are carbon nanomaterials made substantially from carbon, and include, for example, carbon nanotubes (CNT), graphene, graphite carbon nitride, fullerenes, and carbon dots. Organic nanomaterials are made substantially from organic materials (i.e., materials containing hydrogen, carbon, and oxygen) include, for example, liposomes, dendrimers, polymers, and hybrids thereof.

Representative examples of metal nanoparticles include silica nanoparticles, titanium oxide nanoparticles, zinc oxide nanoparticles, copper oxide nanoparticles, silver nanoparticles, and carbon nanotubes. Additional nanomaterials that may be incorporated into the composition are known in the art. See, e.g., U.S. Pat. No. 8,551,243, 8,585,934, 10,922,601, and 11,352,301, and U.S. Patent Application Publication No. 2021/0355041.

Typically, the nanomaterial included in the biodegradable composition will be from about 1 to about 100 nanometers in its shortest dimension. In some embodiments, the nanomaterial is a nanoparticle that has a diameter from about 1 to about 100 nanometers. In some embodiments, the nanomaterial is a nanotube that has a diameter from about 1 to about 100 nanometers and a length from about 0.1 nanometer to about 100 micrometers. In some embodiments, the nanomaterial is a fibril that has a length of about 1 to about 10 micrometers and a width of about 1 to about 100 nanometers.

These biological nanomaterials possess unique properties and can be integrated with or coated with various materials, including Ulva polysaccharides, for example, ulvan. The nanomaterials may be incorporated by intercalation, in situ polymerization, melt processing, and coating. These bionanomaterials may fill the gaps between Ulva polysaccharides, leading to improved barrier and thermal properties. This enhancement may also contribute to improved compressive strength, tensile strength, and resistance to cracking and chemical deterioration. See, De Moura et al., J. Food Eng. 109:520-524 (2012), Khalaf et al., J. Food Dairy Sci. 4:557-573 (2013), Bahrami et al., Int. J. Biol. Macromol. 129:1103-1112 (2019), Roy et al., Food Hydrocoll. 88:237-246 (2019), and Dash et al., Polymers (Basel). 14 (3): 521 (2022).

The process of coating nanomaterials with an Ulva polysaccharide may vary depending on the composition of the nanomaterial. Typically, Ulva polysaccharide coating includes incubating a nanomaterial with the Ulva polysaccharide for a period of time at a set pH and a set temperature. In some embodiments, Ulva polysaccharide coating includes stirring a nanomaterial with the Ulva polysaccharide for about 30 to about 90 minutes at a pH from about 8 to about 10 at a temperature of about 50 to about 80° C., followed by a period of rest, without incubation (i.e., at or below room temperature) and without stirring. In some embodiments, the Ulva polysaccharide is incubated with silver nanoparticles at about 80° C., and at about 7 pH for about 3 hours (See, e.g., Elgamouz et al., Nanomaterials (Basel). 10(9):1861-19 (2020); Mansouri-Tehrani et al., Aquaculture 534:736260-10 (2021); Jacob et al., Biomass Conv. Bioref. S13399-021-01930-y:1-16 (2021); and El-Sheekh et al., Int. J. Phytoremediation 26:1-15 (2021)). The Ulva polysaccharide content in the Ulva polysaccharide-coated nanomaterial may be analyzed in accordance with known techniques to determine Ulva polysaccharide content, nanomaterial size, surface charge, stability, and composition.

Coating an Ulva polysaccharide onto a nanomaterial may enhance one or more properties of the composition. For example, the charge and size of a nanomaterial may change after Ulva polysaccharide coating, the effective particle size of the bound Ulva polysaccharide may increase as it covers the surface of the nanomaterial, and nanomaterial clumping may decrease after Ulva polysaccharide coating, leading to dispersion and increased homogenous distribution of the nanoparticles throughout the composition (i.e., final formed articles), resulting in improved mechanical performance of the composition.

In some embodiments, the nanomaterials may be integrated with the Ulva polysaccharide, such as by intercalation. The intercalation method may be used when nanomaterials and Ulva polysaccharide are pressed together to help dispersion and exfoliation to form a polymer matrix. Intercalation may be performed by mechanical stirring, homogenization (e.g., by rotor-stator homogenization, ultrasonic homogenization, sonication, ultrasonic bath, or a combination of two or more thereof), This integration technique does not necessarily require the use of solvents, is flexible, and reduces the interfacial tension of the component's interaction in the composition. See, Ghoshal, Recent Trends in Active, Smart, and Intelligent Packaging for Food Products. Elsevier Inc., pp. 343-374 (2018) Amsterdam, The Netherlands.

In some embodiments, the nanomaterials may be integrated with the Ulva polysaccharide by in situ polymerization. In situ polymerization occurs when the nanomaterials are added directly with the Ulva polysaccharide solution in conditions suitable for polymerization, often using solvents to integrate the nanomaterial with the Ulva polysaccharide.

In some embodiments, the nanomaterials may be integrated with the Ulva polysaccharide by melt processing. Melt processing involves simultaneous processing of nanomaterial and Ulva polysaccharide through an extruder, injection mold, or other processing machine (e.g., electrospinning), and disperses the nanomaterials throughout the biopolymer, promoting the homogenization of the solution. See, Vilarinho et al., Recent Pat. Food. Nutr. Agric. 11(1):13-26 (2020); and Avella et al., Food Chem. 93:467-474 (2005)

The amount of the nanomaterial in the biodegradable composition generally ranges from about 0.1 to about 10%, in some embodiments, from about 0.1 to about 5%, and in some embodiments, from about 0.5 to about 5%, based on the total weight of the composition. In some embodiments, the amount of the nanomaterial in the biodegradable composition is about 1%, about 2%, about 3%, about 4%, about 5%, about 6%, about 7%, about 8%, about 9%, or about 10%, based on the total weight of the composition.

### Non-Ulva Biomass

The non-Ulva biomass may be obtained from any organic material other than an Ulva species. The term “biomass” as used herein refers to organic material obtained from living organisms (e.g., as an extract) such as plants, animals (including mammals and crustaceans), bacteria, fungi (mycelial), and algae. As known in the art, “biomass” contains a mixture of compounds, including polysaccharides (e.g., cellulose, hemicellulose, and derivatives thereof (e.g., cellulose acetate)), sugars, organic polymers (e.g., lignin), fats, and proteins (Liu et al., Iscience 26(9):107671 (2023)). The presence of the non-Ulva biomass may further reduce the amount of waste and pollutants, thereby reducing the carbon footprint of the article in which they are incorporated. In some embodiments, the non-Ulva biomass is an algal biomass, a plant biomass, a mycelial biomass, or a combination of two or more thereof.

In some embodiments, the biomass contains a substantially purified mixture of polysaccharides from different origins. The term “substantially purified” as used herein in the context of biomass polysaccharides refers to a mixture of polysaccharides from different origins that may be substantially or essentially free of other components which normally accompany or interact with the biomass polysaccharides in its natural state, or prior to purification. By way of example, a mixture of biomass polysaccharides may be “substantially purified” when the preparation of the component of interest contains less than about 30%, less than about 25%, less than about 20%, less than about 15%, less than about 10%, less than about 5%, less than about 4%, less than about 3%, less than about 2%, or less than about 1% (by dry weight) of other components. In some embodiments, a substantially purified biomass is at least about 90%, about 95%, about 96%, about 97%, about 98%, or about 99% pure. In some embodiments, the biomass contains almond waste, wood waste, red seaweed biomass, brown seaweed biomass, lignocellulose, starch, chitin, chitosan, or a combination of two or more thereof.

In some embodiments, the biomass contains lignin, gellan gum, chitosan, carboxymethyl chitosan, carboxymethyl cellulose, glucomannan (e.g., konjac glucomannan), gelatin, or a combination of two or more thereof.

Red seaweed (Division Rhodophyta), also referred to as red algae, is one of the largest phyla of algae, containing over 7,000 currently recognized species. Red seaweed species are found in the Florideophyceae class, and mostly consist of multicellular, marine algae, including many notable seaweeds. The source of red seaweed species is not critical. In some embodiments, the biomass is produced from a species of Gracilaria, Eucheuma, Palmaria, Porphyra, Chondrus, Gelidium, or a combination of two or more thereof.

The main polysaccharide obtainable from red seaweed biomass are carrageenan and agar. In some embodiments, the substantially purified biomass is carrageenan, agar, or a mixture of carrageenan and agar. Carrageenan is primarily composed of linear sulfated polysaccharides. These polysaccharides are classified into three main types based on their chemical structure and degree of sulfation, namely κ (kappa) carrageenan, ι (iota) carrageenan, and λ (lambda) carrageenan. K carrageenan contains repeating units of galactose with sulfate groups attached to some of the carbon atoms. It forms strong gels in the presence of potassium ions. Iota carrageenan also contains of galactose repeating units but with higher levels of sulfation compared to κ carrageenan and λ carrageenan has a lower degree of sulfation. Carrageenan may also contain small amounts of other sugars, such as glucose and xylose. Generally, the carrageenan content in red seaweed ranges from about 30 to about 60% of dry weight but can be as high as about 70 to about 80% dry weight.

Agar is primary composed of agarose, accounting for about 70-80% of its dry weight composition. Agarose is a linear polymer made up of repeating units of agarobiose, consisting of D-galactose and 3,6-anhydro-L-galactopyranose.

Brown seaweed (Class Phaeophyceae), also referred to as brown algae, is a large group of multicellular algae, including many seaweeds located in colder waters within the Northern Hemisphere. They constitute the major seaweeds of the temperate and polar regions. Any brown seaweed species may be used as a source for a non-Ulva biomass. In some embodiments, the biomass is produced from a species of Saccharina, Macrocystis, Nereocystis, Sargassum, Undaria, Fucus and Alaria, or a combination of two or more thereof.

The main polysaccharides from brown seaweed biomass are alginate and fucoidan. In some embodiments, the biomass is alginate, fucoidan, or a mix of alginate and fucoidan. Alginate consists of two monomers: D-mannuronic acid (M) and L-guluronic acid (G). Typically, alginate samples are described using an M/G ratio, which represents the relative abundance of the two monomers. The M/G ratio can range from about 0.2 to about 2.0 or higher.

Fucoidan is a complex polysaccharide. It is composed of various sugars including fucose, galactose, mannose, xylose, and glucuronic acid. The presence of sulfates and acetyl groups can further modify the structure of fucoidan. It is generally estimated that fucoidan constitutes about 1 to about 10% of the dry weight of brown seaweed. Brown seaweed may also contain carrageenan content in the range of about 20 to about 35% of dry weight.

In some embodiments, the biomass may be a mix of carrageenan, agar, alginate, and fucoidan.

Lignocellulose refers to plant biomass and is composed of three main components, two kinds of carbohydrate polymers, cellulose and hemicellulose, and lignin, an aromatic-rich polymer. In some embodiments, the substantially purified biomass is cellulose, hemicellulose, lignin, or a mix of cellulose, hemicellulose, and lignin. Cellulose is a linear polysaccharide found in the cell walls of plants, including trees and grasses. It is composed of repeating units of glucose and serves as one of the main structural component plant cell walls. Cellulose is biodegradable and can be broken down by many bacterial and fungal cellulases. The percentage of cellulose in a biomass may vary depending on the species from which it is obtained, the age of the plant material, and the processing method used. In general, wood is composed of about 40 to about 50% cellulose. The cellulose content in almond waste can range from about 20% to about 40% of the dry weight, depending on the specific part of the almond and the processing method used.

Hemicellulose is a branched polymer made up of various sugar molecules, including xylose, glucose, mannose, and others. It surrounds and interacts with cellulose fibers, contributing to the overall strength and flexibility of plant cell walls. Hemicellulose is more biodegradable than cellulose and lignin. Hemicellulose has a less rigid and more amorphous structure, making it more accessible to microbial enzymes and therefore more biodegradable. Bacterial and fungal hemicellulases are a diverse group of enzymes that hydrolyze hemicelluloses to release the individual sugar units.

The percentage of hemicellulose in wood and almond wastes varies depending on the specific species of wood or plant product (e.g., almonds), the age of the material, and the processing method used. In general, wood hemicellulose content can range from about 15% to about 35% of the dry weight. In almond waste, hemicellulose content can vary depending on the specific part of the almond being considered. Almond shells, which are the hard outer layer of the almond, generally contain higher hemicellulose content compared to the almond kernel (the edible almond). Almond shells typically have hemicellulose content ranging from about 25 to about 35% of the dry weight.

Lignin is a complex, amorphous polymer that fills the spaces between cellulose and hemicellulose in plant cell walls. It is composed of phenolic compounds, primarily coniferyl, sinapyl, and p-coumaryl alcohols, which are synthesized in the plant through a process called lignification. Lignin is considered slow to biodegrade due to the complexity of its bonds and cross-linkages, and because it has a relatively low nitrogen content. However, certain microorganisms, such as white rot fungi and some bacteria, can break it down over time.

The percentage of lignin in wood biomass varies depending on the species from which it is obtained and its age. On average, lignin makes up about 20% to about 35% of the dry weight. The percentage of lignin in almond wastes can range from can range from 10% to 30% of the dry weight.

Chitin and chitosan are related polysaccharides found in the exoskeletons of arthropods (such as insects and crustaceans) and the cell walls of fungi. In some embodiments, the substantially purified biomass is chitin, chitosan, or a mixture of chitin and chitosan. Chitin and chitosan are composed of modified glucose units. Chitin is biodegradable and is broken down by bacterial and fungal chitinases. The chitin content in insects can range from about 10% to about 40% of the dry weight, depending on the species and life stage. The chitin content in crustaceans such as crab, lobster, and shrimp can range from about 15% to about 40% of the dry weight.

In some embodiments, the biomass is substantially purified.

The amount of the non-Ulva biomass in the biodegradable composition generally ranges from about 0.1 to about 5%, and in some embodiments, from about 0.5 to about 5%, based on the total weight of the composition.

### Non-phthalate Plasticizer

The non-phthalate plasticizer in the biodegradable composition is a low-volatility liquid or solid substance that may improve the flexibility, workability, and/or distensibility of the composition to improve forming, shaping, and molding. The most common types of plasticizers used in commercial articles include phthalates, dicarbonates (pyrocarbonates), phosphates, and fatty acid esters.

Phthalate plasticizers, e.g., di-(2-ethylhexyl) phthalate (DEHP), diisononyl phthalate (DINP) and terephthalates, were once preferred plasticizers due to their ability to improve physical characteristics, and their permanence in the polymer over time, even when exposed to relatively high temperatures and humidity. However, public sentiment has prompted many manufacturers of plastic products to discontinue use of phthalate plasticizers due to concerns over potential adverse health effects. Dicarbonates are often used in applications which require lower shaping temperatures. Phosphates are often used to in applications that require flame resistance. Fatty acid esters are often used in applications that require flexibility.

In some embodiments, the non-phthalate plasticizer is a biological plasticizer, also referred to herein as a bio-plasticizer. Biological plasticizers may be obtained from a living organism (e.g., as an extract or a purified molecule) or as a byproduct of a living organism such as plants, animals, bacteria, fungi, or algae, and are biodegradable, which reduces the amount of waste and pollutants, thereby reducing the carbon footprint of the composition and final article to which they are incorporated. Furthermore, biological plasticizers have low toxicity, reducing the risk of harm to both humans and the environment.

In some embodiments, the biological plasticizer is obtained from starch, cellulose, vegetable oil, Tall-oil, citric acid, lecithin, wax, amino acids, or a combination of two or more thereof.

In some embodiments, the biological plasticizer is an organic polymer, an aliphatic dibasic acid ester, a benzoate ester, a trimellitate ester, a polyester, a citrate, or a combination of two or more thereof. In some embodiments, the biological plasticizer is sorbitol, glycerol (i.e., glycerine or glycerin), mannitol, sucrose, a lecithin (e.g., soy lecithin and sunflower lecithin), a glycol ester (e.g., polyethylene glycol (PEG), triethyleneglycol di-(2-ethylhexanoate), and propylene glycol), an epoxidized vegetable oil, or a combination of two or more thereof. In some embodiments, the biological plasticizer is polylactic acid (PLA) or a polyhydroxyalkanoate (PHA), which may be a corn-based derivative or a derivative from another plant.

In some embodiments, the epoxidized vegetable oil is epoxidized soybean oil (ESBO), epoxidized soybean oil fatty esters, epoxidized linseed oil (ELO), castor oil, palm oil, or a combination of two or more thereof.

In some embodiments, the aliphatic dibasic acid ester is a glutarate, an adipate, an azelate, a sebacate, or a combination of two or more thereof.

In some embodiments, the benzoate ester is ethylene, diethylene glycol dibenzoate (DEGDB), dipropylene glycol dibenzoate (DPGDB), triethylene glycol dibenzoate (TEGDB), 1,2-propylene glycol dibenzoate (PGDB), isodecyl benzoate, isononyl benzoate, 2-ethylhexyl benzoate, dipropylene glycol monobenzoate, diethylene glycol monobenzoate, or a combination of two or more thereof.

In some embodiments, the trimellitate ester is tri-2-ethylhexyl trimellitate (TOTM), tri-n-octyl trimellitate (n-TOTM), triisononyl trimellitate (TINTM), or a combination of two or more thereof.

In some embodiments, the polyester is polyethylene terephthalate, poly-1, 4-cyclohexylene-dimethylene terephthalate, a plant-based polyester, or a combination of two or more thereof.

In some embodiments, the citrate is a citric acid ester, tributyl citrate, an acetylated tributyl citrate, acetyl (2-ethylhexyl) citrate, or a combination of two or more thereof.

In some embodiments, the biological plasticizer contains acetylated castor oil, methyl epoxy soyate, amyl epoxy soyate, nonyl epoxy soyate, di-caprylsebacate, acetylated ester, octyl epoxy stearate, tall-oil fatty esters, a fatty ester, cardanol acetate, glycerol, citrates, adipates (e.g., dihexyl, hexyl, and cyclohexyl), polyadipates, trimellitates, sebacates (e.g., dibutyl), or a combination of two or more thereof.

The amount of the non-phthalate plasticizer in the biodegradable composition generally ranges from about 1% to about 50% of the composition, in some embodiments, from about 1% to about 40%, based on the total weight of the composition, in some embodiments, from about 1% to about 25%, based on the total weight of the composition, in some embodiments, from about 1% to about 10%, based on the total weight of the composition, and in some embodiments, from about 1% to about 2%, based on the total weight of the composition. In some embodiments, the amount of the non-phthalate plasticizer in the biodegradable composition ranges from about 5% to about 20%, based on the total weight of the composition.

Yet other examples of non-phthalate plasticizers that may be suitable for use in the biodegradable compositions are described in Bocqué et al., J. Polym. Sci. Part A: Polym. Chem. 54:11-33, U.S. Pat. No. 6,969,735, 8,552,098, 8,557,139, 8,697,787, 8,802,988, 8,829,093, 9,499,681, 9,586,918 9,725,573, 10,030,119, 10,113,051, 10,144,812, 10,262,767, 10,407,559, and 10,717,846, and U.S. Patent Application Publication Nos. 2006/0276575, 2015/0252173 and 2016/0312003.

In some embodiments, the biodegradable composition contains an additive. Additives may widen the range of applications for which the Ulva polysaccharides can be used.

Representative examples of types of additives that may be useful in the present disclosure include stabilizers, nucleating agents, clarifying agents, flame retardants, antioxidants, colorants, anti-odor agents, fillers, water, preservatives, moisture barrier agents, anti-static agents, coupling agents, curing agents, foaming/blowing agents, impact modifiers, lubricants, and processing aids. Additives may be synthetic or obtained from a living organism (i.e., biological) e.g., as an extract or a purified molecule) or as a byproduct of a living organism.

Representative examples of stabilizers that may be useful in the present disclosure include heat stabilizers, UV stabilizers, oxidation stabilizers, ozonolysis stabilizers, and photo-oxidation stabilizers. UV stabilizers, also referred to as UV absorbents, are compounds that protect against photo-oxidation from UV radiation. Photo-oxidation stabilizers are compounds that protect against photo-oxidation from visible light radiation and non-UV radiation. Antioxidants are compounds that prevent oxidation from oxygen molecules. A single compound may have properties of one or more of a UV stabilizer, a photo-oxidation stabilizer, and an antioxidant.

Representative examples of UV stabilizers that may be useful in the present disclosure include paints, dyes, elemental carbon black, benzotriazoles, hydroxy-phenyltriazines, and nickel. UV stabilizers sold under the trade names ColorMatrix™ and OnCap™ by Avient, and Cyasorbh Cyxtra® and Cyasorb Cynergy Slutions® by Solvay may also be useful in the present disclosure.

In some embodiments, the UV stabilizer is a naturally occurring ingredient, i.e., biological. Representative examples of biological UV stabilizers that may be useful in the present disclosure include ferulic acid, polyphenols (e.g., curcumin), and various flavonoids from grapes, tea, and citrus fruits and extracts from plants include green tea, rosemary, and olive leaves. Certain natural waxes and oils such as beeswax oil, cinnamon oil, and jojoba oil may be used to provide a barrier against UV radiation. Bio-nanoparticles such as zinc oxide derived from natural zinc minerals may be used as UV blockers.

Importantly, antioxidants may also serve as barrier or anti-permeation additives to protect from permeation of gases, especially oxygen. In some embodiments, the antioxidant is synthetic. Representative examples of synthetic antioxidants that may be useful in the present disclosure include aromatic amine-containing compounds, phosphites, and thioesters, e.g., that are sold under the trade names, Irganox® 126, Irganox® 168, Irganox® E 201, Irganox® FS 301, Irganox® 245, Irganox® 565, Irganox® PS 800, Irganox® PS 802, Irganox® 1010, Irganox® MD 1024, Irganox® 1078, Irganox® 1098, Irganox® 1135, Irganox® 1330, Irganox® 1520 L by BASF, and Cyanox LTDP by Solvay.

In some embodiments, the antioxidant is biological. Representative examples of biological antioxidants that may be useful in the present disclosure include extracts rich in ascorbic acid such as citrus fruits, green tea, and grape seeds. Polyphenolic flavonoids such as quercetin and catechins from fruits, vegetables, and green tea may also be useful. Tocopherols (e.g., vitamin E) extracted from nuts or vegetable oils may be incorporated into biodegradable compositions to prevent oxidation of fats and oils. Carotenoid pigments such as lycopene (derived, for example, from tomatoes and other red and pink fruits) and anthocyanins (derived, for example, from mulberries, saffron petals, or Açai berries) may be used to prevent oxidation.

Anti-odor agents include both synthetic and biological agents. Representative examples of synthetic anti-odor agents that may be useful in the present disclosure are sold under the trade names OdorClear™ by Ampacet, BYK-MAX by BYK-Chemie, TEGO® SORB PY 88 TQ by Evonik, and Ecosorb 206 by Ecosorb.

Representative examples of biological anti-odor agents that may be useful in the present disclosure include compounds extracted from green tea to provide a pleasant scent. Limonene is a terpene derived from citrus fruits that may be used as an anti-odor agent due to its natural aroma and odor-neutralizing properties. Essential oils such as Eucalyptus oil and thyme oil may be used to provide pleasant fragrance and antimicrobial properties.

In some embodiments, the colorant is a compound classified as a pigment in the Color Index™ (C.I.) published by The Society of Dyers and Colourists and American Association of Textile Chemists and Colorists. Representative examples of such colorants that may be useful in the present disclosure include C.I. Pigment Yellow 1, C.I. Pigment Yellow 3, C.I. Pigment Yellow 12, C.I. Pigment Yellow 13, C.I. Pigment Yellow 138, C.I. Pigment Yellow 150, C.I. Pigment Yellow 180, and C.I. Pigment Yellow 185, C.I. Pigment Red 1, C.I. Pigment Red 2, C.I. Pigment Red 3, C.I. Pigment Red 254, and C.I. Pigment Red 177, C.I. Pigment Blue 15, C.I. Pigment Blue 15:3, C.I. Pigment Blue 15:4, and C.I. Pigment Blue 15:6, C.I. Pigment Violet 23:19 and C.I. Pigment Green 36.

In some embodiments, the colorant is a compound defined in the Food Additives Status List, formerly called Appendix A of the Investigations Operations Manual (IOM). Representative examples of such colorants that may be useful in the present disclosure include Red No. 3, Red No. 104, Red No. 106, Red No. 201, Red No. 202, Red No. 204, Red No. 205, Red No. 220, Red No. 226, Red No. 227, Red No. 228, Red No. 230, Red No. 401, Red No. 505, Yellow No. 4, Yellow No. 5, Yellow No. 202, Yellow No. 203, Yellow No. 204, Yellow No. 401, Blue No. 1, Blue No. 2, Blue No. 201, Blue No. 404, Green No. 3, Green No. 201, Green No. 204, Green No. 205, Orange No. 201, Orange No. 203, Orange No. 204, Orange No. 206, and Orange No. 207.

In some embodiments, the colorant is natural. Representative examples of natural colorants that may be useful in the present disclosure include iron oxide, iron hydroxide, iron titanate, gamma-iron oxide, yellow iron oxide, ocher, black iron oxide, carbon black, manganese violet, cobalt violet, chromium hydroxide, chromium oxide, cobalt oxide, cobalt titanate, Prussian blue, ultramarine blue, titanium oxide, titanium oxide-coated mica, titanium oxide-coated colored mica, bismuth oxychloride, titanium oxide-coated bismuth oxychloride, titanium oxide-coated talc, fish scale foil, aluminum powder, copper powder, stainless steel powder, lead sulfate, carminic acid, laccaic acid, carthamin, brazilin, crocin, phthalocyanine, azo, diazo, quinacridone, hydrazine, and flavanthrone, perinone, perylene, chrome yellow, zinc yellow, chrome vermilion, chrome green, Bengal red, cobalt, and cobalt green.

In some embodiments, the colorant is synthetic. Representative examples of synthetic colorants that may be useful in the present disclosure include a poly(aryleneethynylene) (PAE) polymer (e.g., poly(p-phenylene), a poly(p-phenyleneethynylene) (PPE), apoly(p-phenylenevinylene), PAE derivatives (e.g., alkyl-PPE derivatives, alkyl phenyl-PPE derivatives, akloxy-PPE derivatives, and ternary benzothiadiazole-co-alkyne-co-alkyne derivatives), polythiophene, and polyaniline. In some embodiments, the synthetic colorant is an altered biological or natural dye, e.g., a dye made hydrophilic or hydrophobic through reaction with an oil or fluorine compound.

In some embodiments, the colorant is biological. Representative examples of biological colorants that may be useful in the present disclosure include compounds derived from plant extracts, such as beetroot or turmeric, which may be used to add color in place of synthetic dyes.

Nucleating and clarifying agents may modify the Ulva biopolymer fine structure during molding. The addition of these agents may improve one or more mechanical properties (e.g., flexural modulus and heat distortion temperature) as well as transparency. They may also improve the crystallization temperature, which leads to a shorter molding cycle, thereby contributing to improvement in production efficiency and cost reduction.

Flame retardants are used in applications in which there is a possibility of the Ulva polysaccharide combusting as a result of exposure to high temperatures during use, such as the articles used in electrical cables, electrical devices, and office automation equipment. Flame retardants may be classified according to their mechanism of action, for example flame retardants that decompose and generate water and evaporative latent heat, thereby lowering the temperature of the Ulva polysaccharide; flame retardants that prevent progress of the combustion reaction through chemical means, and flame retardants that form a foamed layer which acts as a barrier against heat and oxygen.

In some embodiments, the flame retardant is biological. Representative examples of biological flame retardants that may be useful in the present disclosure include phosphates derived from natural sources, which may be added to compositions to meet fire safety regulations while reducing the use of traditional, less eco-friendly flame retardants. In some embodiments, the flame retardant is present in an amount of about 5 to about 30%, and in some embodiments, from about 10 to about 20%, based on the total weight of the composition.

In some embodiments, the moisture barrier agent is synthetic or non-biological. Representative examples of synthetic or non-biological moisture barriers that may be useful in the present disclosure include an alkyl ketene dimer (AKD) (e.g., AKD 8o), a long chain diketene, styrene-butadiene, styrene-acrylic, ethylene-vinyl acetate, paraffin wax, butadiene-methyl methacrylate, vinyl acetate-butyl acrylate, clay, talc, silica (e.g., needle-like, plate-like, or porous silica), silicon (e.g., sodium and potassium siliconates), silicone (wax or oil), zeolite, titanium dioxide, zirconium dioxide, dolomite (e.g., calcined dolomite), sodium polyacrylate, potassium polyacrylate.

In some embodiments, the moisture barrier agent is biological. Representative examples of biological moisture barriers that may be useful in the present disclosure include proteins, such as soy protein and whey protein.

Additional moisture barrier agents that may be suitable for use in the biodegradable compositions are described in U.S. Pat. No. 4,059,553, 5,689,601, 7,947,772, 9,052,458, 9,260,607, 9,768,386, 9,806,293, 9,856,608, and 10,093,789, U.S. Patent Application Publication Nos. 2015/0037535, 2017/0210932, and 2020/0032067, and International Patent Application Publication No. WO 2019/187717.

In some embodiments, the gas barrier agent makes up about 0.1 to about 10.0%, based on the total weight of the biodegradable composition. In some embodiments, the moisture barrier agent makes up about 0.1 to about 3.0%, based on the total weight of the biodegradable composition.

In some embodiments, the gas barrier agent is clay, silica, alumina, silicon (e.g., silicon oxide), silicone, aluminum oxide, a montmorillonite, a polyvinyl alcohol (PVA) (e.g., silica-PVA), ethylene-vinyl alcohol (EVOH), polyvinylidene chloride (PVDC), a polyepoxide-polyamine, vinylidene chloride, metaxylilene adipamide, a metal alkoxide, a metal hydrolysate, polyethylene naphthalate (PEN), nylon (e.g., polyamid-6 nylon and Nylon-MXD6), a polyamine, a metaxylylenediamine, a paraxylylenediamine.

Additional gas barrier agents that may be suitable for use in the biodegradable compositions are described in U.S. Pat. No. 4,018,746, 5,215,822, 5,260,350, 5,368,941, 5,374,483, 6,309,757, 6,346,596, 6,447,845, 6,569,533, 6,861,147, 6,979,493, 7,267,877, 7,666,486, 8,128,782, 8,822,001, 9,605,122, and 10,647,080, and U.S. Patent Application Publication Nos. 2006/0078740, 2009/0321681, 2015/0059295, and 2022/0315694.

In some embodiments, the gas barrier agent makes up about 0.1 to about 10.0%, based on the total weight of the biodegradable composition. In some embodiments, the gas barrier agent makes up about 0.1 to about 3.0%, based on the total weight of the biodegradable composition. Most plastics are insulators and therefore do not readily discharge static electricity produced by friction and are therefore prone to static buildup. Static buildup results in adhesion of dust and dirt to the plastic, resulting in issues such as noise generation in office automation equipment. Antistatic agents are used as coating or kneading-type agents in plastics. Most antistatic agents are based on surfactants that combine within their molecules a hydrophilic group for emission of electric charge with a hydrophobic group for improved affinity with the plastic.

Lubricants reduce the friction between the plastic particles and the processing machine during molding. Therefore, lubricants are effective for improving the fluidity and mold-release properties of the plastic, and for enhancing the processing efficiency and appearance of the resulting molded article. Some lubricants act as external lubricants and some are effective for improving internal lubricity; typically, both types are used in combination. In some embodiments, the lubricants make up about 0.1 to about 2%, and in some embodiments, from about 0.2 to about 1%, based on the total weight of the composition.

Additional additives that may be suitable for use in the biodegradable compositions are described in U.S. Pat. No. 5,804,623, 8,877,862, 9,334,360, 10,138,354, 10,323,136, 10,370,537, 10,450,442, 10,544,284, 10,870,733, and 11,591,450, and U.S. Patent Application Publication Nos. 2020/0231783 and 2020/0361879.

The total amount of additive(s) in the biodegradable composition generally ranges from about 0.1 to about 2%, and in some embodiments, from about 0.3 to about 1.5%, based on the total weight of the composition.

### Forms of the Compositions

In some embodiments, the biodegradable composition is in the form of a resin. The term “resin” as used herein refers to a biodegradable composition in the form of free-flowing granules or particles, wet pulps, gels, emulsions, dry powder, dry flakes, dry pellets, wet pellets, capsules, or wet pastes, or aqueous compositions. In some embodiments, the resin composition is mixed with or added to water to form an aqueous resinous composition containing an Ulva polysaccharide, a nanomaterial, a non-Ulva biomass, a non-phthalate plasticizer, and water. The form of the biodegradable composition may depend on factors such as product functionality, ease of application, and consumer preference.

In some embodiments, the process for preparing a resin composition includes heating a biodegradable composition containing an Ulva polysaccharide, a nanomaterial, a non-Ulva biomass, a non-phthalate plasticizer, often within a reactor. A catalyst is added after heating to induce re-formation of any broken polymers. Additives may be added with the catalyst, if desired. The heated composition is chopped and shaped into the desired resin form, e.g., granules or pellets.

In some embodiments, the biodegradable composition is formulated in a delivery system for spray or coating applications. In such embodiments, the biodegradable composition further contains a propellant. Propellants are typically in a gaseous form at 25° C. and 1 atmosphere, but they may be in a different phase (e.g., a liquid) under pressure, such as in a pressurized aerosol delivery system. The propellant may be a complex gas (e.g., air), a substantially purified gas (e.g., nitrogen), a mixture of substantially purified gases (e.g., oxygen, nitrogen, and carbon dioxide), or a liquefiable gas having a vapor pressure sufficient to propel and aerosolize the biodegradable composition as it exits the delivery system.

Representative examples of propellants that may be useful in the present disclosure include liquefied petroleum gases, ethers (e.g., dimethyl ether (DME) and diethyl ether), C1-C4 saturated hydrocarbons (e.g., methane, ethane, propane, n-butane, and isobutene), hydrofluorocarbons (HFC) (e.g., 1,1.1,2-tetrafluoroethane (norflurane; R-134a; HFC-134a), 1,1,1,2,3,3,3,-heptafluoropropane (heptafluoropropane; apaflurane; HFC-227), difluoromethane (HFC-32), 1,1,1-trifluoroethane, 1,1,2,2-tetrafluoroethane (HFC-134), 1,1-difluoroethane (HFC-152a)), hydrofluoroalkanes (e.g., 1,1,1,3,3-pentafluoropropane and 1,1,1,3,3-pentafluorobutane, 1,1,1,3,3,3-hexafluoropropane (HFC-236fa), 1,1,1,2,3,3,3-heptafluoropropane (HFC-227ea), 2-chloro-1,1,1,2-tetrafluorpropane (HCFC-244bb), and 1,1,1,2,3,4,4,5,5,5-decafluoropentane (HFC-43-10mee)), isobutane, and C-17/21 OH 20-ketosteroids. In some embodiments, the propellant is a blend of n-butane and propane.

Additional propellants and delivery systems that may be suitable for use with the biodegradable compositions are described in U.S. Pat. No. 6,315,985, 7,223,381, 7,448,517, 7,468,467, 8,426,658, 8,796,493, 9,139,744, 9,181,151, 9,388,325, 9,493,384 10,047,026, and 10,280,332, and U.S. Patent Application Publication Nos. 2012/0204871 and 2018/0140787.

In some embodiments, the biodegradable composition containing the Ulva polysaccharide is in the form of a resin while the Ulva polysaccharide is in the form of a hydrogel. The properties of the biodegradable composition depend on the overall balance of hydrophilic and hydrophobic components, as well as the structure and interactions between the components. Therefore, in some embodiments, the Ulva polysaccharide contributes to hydrogel properties of a biodegradable composition, the Ulva polysaccharide may exist as a hydrogel in an otherwise, biodegradable composition that is not in a hydrogel form.

The biodegradable compositions disclosed herein may be packaged in bags, boxes, and the like for the purposes of sale and distribution.

### Biodegradable Articles

In one aspect, the disclosure provides a biodegradable article which has a desired shape and size, and which is formed from a biodegradable composition containing an Ulva polysaccharide, a nanomaterial, a non-Ulva biomass, and a non-phthalate plasticizer. The term “article” as used herein refers to any item made, formed, molded, extruded, or cast from a biodegradable composition as described herein.

The biodegradable compositions may be used to replace a traditional, non-biodegradable fossil-fuel derived plastic and articles formed from them. Examples of fossil-fuel derived plastics include polyethylene terephthalate (PETE or PET), high-density polyethylene (HDPE), polyether ether ketone (PEEK), ethylene vinyl alcohol (EVOH), polyamides (e.g., polyamide 12 or Nylon 12), polyimides (PI), polytetrafluoroethylene (PTFE) (e.g., Teflon®), polyvinyl chloride (PVC), low-density polyethylene (LDPE), polypropylene (PP), polystyrene (PS), polycarbonate (PC), polylactic acid (PLA), acrylonitrile butadiene styrene (ABS), acrylonitrile ethylene styrene (AES), acrylonitrile styrene acrylate (ASA), polybenzimidazole (PBI), polyketone (PK), polyether imide (PEI), polyphenylene ether, polyvinylidene dichloride (PVDC), polysulfone (PSU), and polyphenylene sulfide (PPS).

The nature and type of article is not limited to any particular shape, size, or use. It may be in the form of any article made from a traditional, non-biodegradable fossil-fuel derived plastic. In some embodiments, the article is a beverage bottle, microwavable package, retail bag, milk jug, bearing, piston part, pump, HPLC column, compressor plate valve, cable insulation, food wrap, plumbing pipe, window, grocery bag, wrap, bottle, yogurt container, prescription bottle, rope, disposable plate, take-out container, packing material, electronic housing, an auto part, a consumer product, a pipe fitting, tubing, tubing layer, toy, Lego toy, automotive part, a pool step, a truck cap, ceramic tile adhesive, a filler, a putty, a roof coating, firefighting gear, astronaut gear, an aircraft interior part, an electrical system part, a lighting system part, or a medical device part.

In some embodiments, the article is a coating. Coatings may be used to cover a food product. Coatings may be deposited onto an object by spraying or by immersion (dipping). While coatings are typically thinner than films, their thickness depends on their application method. Coatings are not generally relied upon for structural integrity but may instead serve various purposes based on composition and application. Coatings may reduce the environmental impact of plastic waste and to provide functional properties like enhanced barrier properties, heat retention, or improved printability. Additionally, coatings may offer aesthetic enhancements enhance the visual appeal of the packaging, for example, gloss, matte finish, or special effects. Without being bound by theory, coatings formed from the biodegradable compositions described herein may not be intended to be consumed as food, but may be safely ingested, especially in small quantities. Some common coatings, e.g., polyvinyl alcohol (PVA), beeswax-or soy wax-based coatings are not edible but are water-soluble and used as packaging in non-food products, e.g., loose fill packaging and coatings on washing and cleaning materials (e.g., laundry detergent pods, dishwasher pods, rinse aids, machine cleaner, and hard surface cleaners), water softeners, cosmetics, pharmaceuticals, and other single-use items. Coatings formed from the biodegradable compositions described herein may be used as environmentally friendly water-soluble coatings, that possess improved water resistance and barrier properties relative to the forementioned common coatings.

In some embodiments, the coating is applied by immersion and has a thickness ranging from about 0.1 μm to about 10 mm, a thickness ranging from about 0.1 mm to about 10 mm, a thickness ranging from about 1 mm to about 10 mm, a thickness about 4 mm, a thickness about, 5 mm, or a thickness about 6 mm. In some embodiments, the coating is applied by spray coating and has a thickness ranging from about 0.1 μm to about 0.10 mm, a thickness ranging from about 0.1 μm to about 10 μm a thickness ranging from about 0.1 μm to about 10 μm, a thickness about 5 μm, a thickness about 6 μm, a thickness about 7 μm, a thickness about 8 μm, a thickness about 9 μm, or a thickness about 10 μm.

Coating procedures and coating additives are known in the art. See, e.g., Cisneros-Zevallos and Krochta, J. Food Science 68(2):503-510 (2003), and Díaz-Montes and Castro-Muñoz, Foods 10(2):249 (2021), U.S. Pat. No. 4,710,228, 6,709,713, and 9,675,088, and U.S. Patent Application Publication Nos. 2014/0363542, 2016/0213030, 2016/0324173, 2017/0303575, 2018/0325135, 2023/0048027, and 2023/0134284.

In some embodiments, the article is a film. Films formed from the biodegradable composition are continuous material that are thin, often stored wound on a core or cut into sections.

Films are defined in International Standard ASTM publication D883 as an optional term for sheeting having a nominal thickness no greater than 0.25 mm (0.010 in.). ASTM D6988 is incorporated herein by reference. Often, films have a thickness ranging from about 0.06 mm (0.00025 in.) to about 0.25 mm (0.010 in.). In some embodiments, the film has a thickness of about 0.11 to about 0.25 mm. Articles thicker than 0.25 mm are commonly defined as sheets. In some embodiments, the article is a sheet. In some embodiments, the sheet has a thickness of about 0.25 mm to about 0.5 mm. In some embodiments, the Ulva polysaccharides are crosslinked to form into films and used to reduce water vapor transfer rates between a packaged food and the environment.

In some embodiments, the film is transparent. Transparency of a film may be demonstrated by Lightness (L*), red/green (“greenness”) (a*), and yellow/blue (“yellowness”) (b*) as measured by a colorimeter, and opacity as measured by a spectrophotometer. Representative transparency values for a film as described herein generally range from about 75 to about 100 L*, from about −10 to about 10 a*, from about 0 to about 20 b*, and have an opacity in a range from about 0 to about 10 nm/mm. In some embodiments, the film lightness ranges from about 80 to about 90 L *. In some embodiments, the film greenness ranges from about −10 to about 1 a*, and in some embodiments, from about −2 to about 0 a *. In some embodiments, the film yellowness ranges from about 0 to about 15 b*, from about 0 to about 10 b*, from about 5 to about 15 b*, and in some embodiments, from about 10 to about 15 b *.

In some embodiments, the film has a glass transition temperature in the range from about 5 to about 100° C., from about 25 to about 100° C., from about 30 to about 50° C., from about 50 to about 100° C., from about 75 to about 100° C., and in some embodiments, from about 50 to about 75° C.

In some embodiments, the film possesses free radical scavenging activity in the range from about 10 to about 60%, expressed as a percentage inhibition of the 2,2-diphenyl-1-picrylhydrazyl (DPPH) radical, in some embodiments, from about 15 to about 50%, and in some embodiments, from about 20 to about 40%. In some embodiments, the film possesses free radical scavenging activity of about 50%.

In some embodiments, the film possesses ferrous ion-chelating activity in the range from about 5 to about 30% chelating activity, as measured by the reduction of 2,4,6-tri-2-pyridinyl-1,3,5-triazine (TPTZ)-Fe(III) to the TPTZ-Fe(II), and in some embodiments in the range from about 10 to about 25% chelating activity.

In some embodiments, the article is a packaging material. The biodegradable composition may be in a variety of forms. E.g., a thermoformed insert, sheet, blind, door profile, piping, wire insulation, weatherstripping, window profile, windshield wiper, sachet, laminate, banner, loose fill, bubble wrap, inner lining (e.g., for boxes or cardboard), netting, seed strip, twine, tie, clip, tape, thread, glove, mask, gown, or textile.

In some embodiments, the article is in the form of an intelligent packaging material. Intelligent packaging materials, also referred herein as active packaging materials, contain ingredients which prolong the contained product's freshness and storage life, enhance the margin of food safety by altering the condition of the product, and/or providing an indicator of the environment within the intelligent packaging material. Intelligent packaging material with such environmental indicators (e.g., freshness indicators) present a visual indication that may provide valuable information about the quality of the product. Such indicators are typically based on the production of metabolites, often resulting from microbial degradation. Thus, the biodegradable articles described herein may improve the characteristics of food packaging materials by improving the packages properties (e.g., mechanical, optical, thermal, vapor barrier, and gas barrier) as well as providing an intelligent system that provides a visual indicator to the package's environment.

In some embodiments, the intelligent packaging material contains antioxidants (i.e., oxygen scavengers), antimicrobial agents, gas barrier agents, and/or anti-odor agents. In some embodiments, the intelligent packaging material contains additives that enable monitoring the environment in the packaging material by sensing changes in temperature, pH, moisture, gas composition, and/or the presence of microorganisms.

In some embodiments, the intelligent packaging material is formed from a biodegradable composition containing an Ulva polysaccharide, a non-phthalate plasticizer, non-Ulva biomass that includes gellan gum, and silver nanoparticles. Such intelligent packaging materials provide an indicator of hydrogen sulfide (H₂S) exposure by altering visible packaging color when in the presence of H₂S, which is produced during the spoilage of some foods, for example, chicken and fish.

In some embodiments, the intelligent packaging material is formed from a biodegradable composition containing an Ulva polysaccharide, a non-phthalate plasticizer, non-Ulva biomass that includes chitosan, and graphite carbon nitride nanomaterials. Such intelligent packaging materials have improved antimicrobial and shelf-life properties.

In some embodiments, the intelligent packaging material is formed from a biodegradable composition containing an Ulva polysaccharide, a non-phthalate plasticizer, non-Ulva biomass that includes carboxymethyl cellulose, and cobalt-based metal-organic framework nanomaterials. Such intelligent packaging materials provide an indicator of ammonia exposure by altering visible packaging color in the presence of ammonia. Such intelligent packaging materials also have antibacterial properties and enhanced color-stability.

In some embodiments, the intelligent packaging material is formed from a biodegradable composition containing an Ulva polysaccharide, a non-phthalate plasticizer, non-Ulva biomass that includes glucomannan (e.g., konjac glucomannan) and chitosan, zinc oxide nanoparticles, and an additive that includes anthocyanins. Such intelligent packaging materials have improved antioxidant, antibacterial, mechanical, gas barrier, thermal and light-barrier properties. Such intelligent packaging materials also provide an indicator of pH change, by changing color in the presence of high pH (becoming increasingly blue in the presence of pH ranging from about 8 to about 12) and low pH (becoming increasingly red in the presence of pH ranging from about 6 to about 2).

In some embodiments, the intelligent packaging material is formed from a biodegradable composition containing an Ulva polysaccharide, a non-phthalate plasticizer, non-Ulva biomass that includes glucomannan (e.g., konjac glucomannan), pullulan nanomaterials, and an additive that includes anthocyanins, producing an intelligent packaging material with improved water barrier, antioxidant, and antibacterial properties, as well as enabling the intelligent packaging material to demonstrate pH change by visible color change.

In some embodiments, the intelligent packaging material is formed from a biodegradable composition containing an Ulva polysaccharide, a non-phthalate plasticizer, non-Ulva biomass that includes carboxymethyl chitosan, copper oxide nanoparticles, and an additive that includes anthocyanins. Such intelligent packaging materials have improved mechanical, thermal, antioxidant, and antibacterial properties. The intelligent packaging material also demonstrates pH change by visible color change from white/slightly pink at neutral pH (7), transitioning to blue in the presence of pH ranging from about 8 to about 9, becoming increasingly yellow in the presence of pH ranging from about 10 to about 12, and becoming increasingly red in the presence of pH ranging from about 6 to about 2.

In some embodiments, the intelligent packaging material is formed from a biodegradable composition containing an Ulva polysaccharide, a non-phthalate plasticizer, non-Ulva biomass that includes gelatin and chitosan, oxidized cellulose nanofibers, and additives that include curcumin and cinnamon oil. Such intelligent packaging materials have improved antioxidant and UV stabilization properties, as well as enabling the intelligent packaging material to demonstrate pH change by visible color change.

In some embodiments, the article is shaped in the form of a package. Representative forms into which the biodegradable composition may be molded or otherwise prepared include a clamshell, blister pack, coffee pod, box, bag (e.g., waste collection bag, shopping bag), food wrap, food product, sachet, bottle, bucket, liquid tote, barrel, tank, tray, cup, teabag, lid, tub, pouch, jar, capsule, pot, seed strips, twine, agriculture mulch films, replacement parts for electronics, automobile, aerospace, and housewares. The term “food product” as used herein refers to a product in any form (solid, granular, powdered, ground, gel, liquid, or solid) intended for human consumption or used to generate a product intended for human consumption.

In some embodiments, the article is in the form of a plate, straw, utensil (spoons, forks, knifes, and sporks), tie, clip, tape, thread, glove, mask, gown, or textile.

In some embodiments, the article has a moisture content of about 10 to about 32%. Moisture content affects food texture, nutrient, and flavor profiles and impacts the quality and safety of food. The reaction rates of lipid oxidation, microbial growth, and browning are altered when food moisture content changes. In some embodiments, the article has a water vapor permeability (WVP) of about 1 to about 4.5×10⁸ g mm/cm² s Pa. The WVP of an article describes the rate at which water vapor passes through the article when it is exposed to a given water activity or relative humidity (RH) gradient. WVP is a function of the solubility and diffusion of water vapor in an article's material and can be divided into the steps of (1) water vapor adsorption onto the article, (2) water vapor diffusion through the article, and (3) water vapor desorption from the article. The driving force is from high to low water activity or RH (Guidara et al., Int. J. Biol. Macromol. 150:714-726 (2020)).

In some embodiments, the article has a transparency of about 0.5 to about 10 absorbance at 600 nm per mm thickness of the article (A600/mm). Article transparency and opacity may influence the consumer acceptability of a packaged product. Typically, the most desirable characteristic of some articles (e.g., films) is high transparency.

In some embodiments, the article has a tensile strength of about 0.1 to about 4 megapascals (Mpa). Tensile strength of sheets and films is the measure of how the sheet or film article responds to a pull force. For sheet and film applications (e.g., load bearing food wraps or garbage bags) tensile strength is a comparable measurement of how much weight the article may hold before breaking.

In some embodiments, the article includes a label disposed on the article containing information relating the article, the process in which it was created, and/or the company that produced the article. In some embodiments, the information on the label relates to quantifiable units of carbon capture (e.g., from Ulva polysaccharide contained in the article), reduced greenhouse gas (GHG) emissions (which may be expressed in tons of CO₂ equivalent (tCO₂eq)), energy consumed in the production of the Ulva and/or the article, waste effluents or other pollutants (e.g., acid consumed and waste acid), and downstream impacts (e.g., environmental of transportation, distribution, and end-of-life article waste products), certification marks (e.g., a BPI certification), ecolabels, information relating to compostability of the article, reduced water usage, reduced transport costs, specific energy sources, ecological co-benefits, carbon accounting protocol type, and codes for tracking this information.

In some embodiments, the ecolabel is an International Organization for Standardization (ISO) Type I label or an ISO Type I-like label. ISO Type I labels may identify overall environmental preference of an article within a category based upon life cycle considerations. ISO Type I-like labels (often referred to as “certification schemes” or “sustainability labelling”) share the same characteristics as Type I but are typically focused on specific impacts (i.e., energy consumption or agricultural practice), and apply only to a specific sector (i.e., food package articles). See, ISO 14024; ISO 14025; and Wirth, BC Envtl. Aff. Law Rev. 36:79-102 (2009).

In some embodiments, the compostability of the article adheres to ASTM D6400 or ASTM D6868 (often used in American certification and BPI certification), EN 13432 (often used in European certifications), EN 17033 ISO 17088, or ISO 18606. EN 17033 provides specifications for soil biodegradable agricultural mulch films. ISO 17556 and ASTM D5988provide test method for measuring plastics biodegradability in soil. ASTM D6691, D7991 and emerging ISO Standards provide test methods for measuring plastics biodegradability in marine environments. See, Zumstein et al., Environ. Sci. Technol. 53(17):9967-9969 (2019).

In some embodiments, the reduced GHG emission is defined by scope category. Scope 1 emissions are direct GHG emissions that occur from sources owned or otherwise controlled by the reporting company (e.g., boiler, furnace, vehicle emissions, and the like). Scope 2 emissions are indirect GHG emissions associated with the purchase of electricity, steam, heat, or cooling for the use of the reporting company. Scope 3 emissions are GHG emissions that result from assets not owned or controlled by the reporting company, but that the company indirectly affects in its value chain. Scope 3 emissions include use of sold articles, transportation (by third party companies), franchises and the like. Avoided emissions, sometimes referred to informally as Scope 4 emissions are GHG emissions reductions that occur outside an article's life cycle or value chain but as a result of the use of that article. See, for example, ISO 14064; Bhatia and Ranganathan, The Greenhouse Gas Protocol: A Corporate Accounting and Reporting Standard. World Business Council for Sustainable Development (WBCSD) and World Resources Institute (WRI), pp. 1-112 (2004) Washington DC, USA; Bhatia et al., Greenhouse Gas Protocol Corporate Value Chain (Scope 3) Accounting and Reporting Standard. WBCSD and WRI, pp. 1-152 (2011) Washington DC, USA; and Russell, Estimating and Reporting the Comparative Emissions Impacts of Products. WRI, pp. 1-26 (2019) Washington DC, USA.

In some embodiments, the information is printed on the label. In some embodiments, the label contains a link (e.g., a quick response (QR) code) to the information. The link may bring a person who accesses the link to an internet address where information relating to the article may be display. The information displayed may be any of the information described above. In some embodiments, the information is in real time, for example, the current status of certifications or verified credits belonging to the article and/or a company in control of the article's production or consumption. Representative status of verified credits include active, retired (fully or partially), offered for sale on an exchange, and the like.

In some embodiments, the label disposed on the article contains information, e.g., data, relating to environmental, social and governance (ESG). Environmental information may relate to energy usage (including carbon emissions), conservation of energy, waste generation, product recalls, water usage, and animal treatment by the company as a whole, upstream supply chains, and/or consumed in the production of a specific article. Environmental information may relate to the impact of an article that occurs after the company has transferred control of it to another entity (e.g., a consumer or third-party seller). Social information may include a company's social interactions and how those interactions reduce or increase the company's carbon footprint throughout its communication actions. Governance information may relate to the company's management and the execution of business activities (e.g., employee health and safety records, and/or diversity and inclusion efforts). See, Tarmuji et al., IJTEF, 7(3):67-74 (2016); Huang, Accounting & Finance 61:335-360 (2021); Popescu et al., Energies 15(23):en15239028 pp. 1-28 (2022); and Zhang and Chen, PLOS One 18(5):e0279220 pp. 1-24 (2023).

In some embodiments, the label contains information relating to a measurement, reporting, and verification (MRV) process. MR Vis a multi-step process that quantifies the amount of GHG emissions reduced by a specific mitigation activity, such as reducing emissions from the production of articles containing fossil-fuel-based plastics or growing and fixing carbon in Ulva, over a period of time and reporting these findings to an accredited third party. The third party then verifies the report so that the results can be certified, and, in some cases, carbon credits may be issued. An ocean-based carbon dioxide removal MRV process using seaweed has been proposed in which large quantities of kelp may be farmed offshore, transported to a deep water sink site, and then deposited below the sequestration horizon (1,000 m) to trap the grown carbon dioxide. See, e.g., Coleman et al., Front. Mar. Sci., 9:966304 (2022), at pp 1-22. Such a seaweed MRV process may be adapted to produce a MRV process for biodegradable articles described herein.

Establishing an MRV process typically begins with establishing a baseline or reference level against which performance is measured periodically. The assumptions upon which these baselines are established, and the accounting methodologies used to calculate emission reductions vary by sector and scale. Third party standard-setters, e.g., the World Bank, define the requirements that the baselines and MRV activities must meet to ensure the highest accounting standards for trustworthy results.

During the program, data is collected and processed to calculate emission reductions achieved against the baseline/reference during the monitoring period. Depending on the program, data collection may entail tracking the operation of growth conditions, reading electricity meters, measuring waste streams (e.g., measuring waste acid production), and the like.

Emission reductions results may then be compiled into a report that is subject to third-party verification by an accredited entity per the requirements of the standard being used. Once emission reductions are verified, the standard-setter certifies them, signaling the applicable emission reduction transaction registry to issue emissions reduction credits (ERCs). In the case of the World Bank-led standards, these credits are issued and transferred to the Bank's transaction registry so buyers, including World Bank trust funds can pay the country for the proven results. The Bank may also retransfer some or all of the ERCs to the country for NDC fulfillment and credit retirement. The entire MRV cycle may take a year or more to complete. See, Breidenich and Bodaskey, Measurement, reporting and verification in a post-2012 climate agreement. Arlington: Pew Center on Global Climate Change, pp. 1-40 (2009) Arlington, VA, United States of America; and Singh et al., World Resources Institute 4-5:1-28 (2016).

### Methods of Forming Biodegradable Article

In one aspect, the disclosure provides a method of forming a biodegradable article. The method entails preparing a biodegradable composition as described herein and forming the article into a desired shape and size.

In some embodiments, the forming is performed by casting, extrusion, or molding. Extrusion is a manufacturing process that forms a composition or a resin composition in a closed cavity that melts and presses the composition or resin composition through an opining in a die. The die is in a predetermined shape and the composition or resin composition takes on this shape during extrusion. The extruded composition sets as it cools into a desired shape and size.

Extrusion involves loading a hopper of an extruder with solid composition or resin composition, which is fed into the extruder barrel where it is heated and pressed with consistent presser through a die with a desired extrusion profile. The melted, compressed composition retains the shape of the die, taking on the desired shape and size, which is maintained during cooling.

Different extrusion techniques may be used to manufacture different products, including sheet film extrusion and roll extrusion. The formed article (e.g., a film) is sent through rollers after exiting the die in sheet film extrusion. The rollers flatten the material to a specific, desired thickness to create finished, flat sheets. The rollers in sheet film extrusion cause the article to become curved or bent. In roll extrusion, additional cycles of rollers may be used to achieve a desired angle of bend of the article. Articles produced by extrusion may include sheets, blinds, door profiles, piping, wire insulations, weatherstripping, window profiles, and windshield wipers.

Casting involves introducing a liquefied composition into a mold by a casting machine or doctor blade and letting the composition to solidify. Casting relies on atmospheric pressure to fill the mold, unlike molding or extrusion, which use additional forces to push the composition into the mold. Heated compositions with low viscosity are ideal for casting. Evaporation, chemical action, cooling, or external heating may be used to cause the melted composition to solidify. The solidified film may then be removed (e.g., peeled) away from the surface on which it solidified to yield a continuous, and biodegradable film. Typically, the cast film is then allowed to dry under controlled temperature as well as controlled humidity. Films may be further coated or laminated. Biodegradable compositions used to make films may often include antioxidant and antimicrobial additives. Casting of biodegradable compositions is described in, for example, Chiellini et al., Biomacromolecules 9(3):1007-1013 (2008) and U.S. Pat. No. 8,524,811.

Additional examples of film additives and methods for producing films that may be suitable for use in the biodegradable compositions are described in Guidara et al., Int. J. Biol. Macromol. 135:647-658 (2019), Guidara et al., Int. J. Biol. Macromol. 150:714-726 (2020) U.S. Pat. No. 6,528,088, 7,132,113, and 10,570,262 and U.S. Patent Application Publication Nos. 2004/0247646, 2005/0031675, 2005/0233048, 2006/0024425, 2009/0110715, 2010/0240724, 2010/0278899, 2014/0113042, 2014/0302203, 2021/0186064, and 2021/0128439.

Coatings may be prepared by blending biodegradable compositions with solvents prior to direct application onto a packaging material or product surface. Environmentally friendly solvents like water, ethanol, glycerol, dimethyl sulfoxide (DMSO), or ionic liquids may be used, especially with food products. A liquid coating solution (containing the biodegradable composition and solvent) is then directly applied to the packaging material or product (e.g., food) using various methods such as dip coating, spray coating (e.g., electrostatic spray), electrospinning, roller coating, or gravure printing. Following application, the coatings can be cured or dried under controlled conditions, resulting in a durable, continuous, and biodegradable coating.

Eco-friendly, antibacterial food packaging coatings formed from the biodegradable compositions described herein are designed to provide a protective barrier for a wide variety of commercial products, such as food products, while minimizing their impact on the environment. These coatings typically incorporate natural or bio-based materials that have antimicrobial properties, reducing the need for synthetic chemicals that may be harmful. Examples include Chitosan-based coatings and essential oils and edible coatings: Edible coatings are made from natural materials such as proteins, polysaccharides, and lipids. These coatings can form a protective barrier on food products and also provide antimicrobial properties. Edible coatings can help extend the shelf life of food while reducing the need for additional packaging materials.

Other articles such as packages, containers (e.g., coffee pods) and utensils and straws, may be prepared by molding. In some embodiments, the forming is performed by blow molding, injection blow molding, stretch blow molding, or injection molding.

Blow molding is a group of molding processes which involve the process of inflating a hot, hollow, resin composition inside a closed mold, so the resin takes on, or conforms to, the shape of the mold cavity. A wide variety of articles, including plastic bottles, can be produced from many different biodegrade resin compositions using these processes. Extrusion blow molding is one type of blow molding. Typically, a resin composition is dropped from an extruder and captured in a cold (e.g., water cooled) mold. Once the molds are closed, air is injected through the top or the neck of the container and the hot resin is expanded. Once the hot resin touches the walls of the cold mold, the resin “freezes” and the resin will maintain its rigid shape, becoming the article. Colorants and other additives may also be added into the extruder at a controlled rate and mixed with the resin as it is being melted.

The injection blow molding process involves injection, blowing, and ejection. An injection blow molding machine contains an extruder barrel and screw assembly which melts the resin. The melted resin is fed into a manifold where it is injected through nozzles into a hollow, heated preform mold. The preform mold forms the external shape of the now-forming article, referred to in this step as the preform, and is clamped around a mandrel (the core rod) which forms the internal shape of the preform. The preform consists of a fully formed bottle/jar neck with a thick tube of polymer attached, which will form the body of the article.

Next, during blowing, the preform mold opens and the core rod is rotated and clamped into the hollow, chilled blow mold. The core rod opens and allows compressed air into the preform, which inflates it to the finished article shape. Finally, during ejection, the preform mold is allowed to cool; after this cooling period the blow mold opens, and the core rod is rotated to the ejection position. The finished article is stripped off the core rod and typically leak-tested prior to packing. The preform mold and blow mold can have many cavities, typically three to sixteen depending on the article size and the required output. Typically, there are three sets of core rods, which allow concurrent preform injection, blow molding, and ejection.

The injection blow molding process is especially effective for wide-mouthed food article manufacturing, such as tubs, vials, jars, pots, and trays. The resulting article is thin and lightweight to keep the overall product easy to handle. Yet it is also durable, flexible, and resistant to tears, chemical spills and other damage that could spoil the food inside. The process is relatively easy and straightforward. This allows quicker processing times and larger-scale production for bigger packaging projects. The injection blow molding process also provides excellent versatility around the type of polymer chosen (e.g., type of Ulva polysaccharide and type of non-Ulva biomass). This further enables the food container manufacturing to be made with bespoke finishes, shapes, fastenings, colors, printing, and branding.

In some embodiments, a coffee pod is formed from the biodegradable composition by. The process may entail forming a cup by injection blow molding, applying a thin layer of biodegradable composition with low oxygen permeability onto the outer wall of the cup, applying a thin layer of biodegradable composition with low water vapor permeability onto the inner wall of the cup, then attaching a filter into the cup, and providing a cover configured to attach securely onto the top of the cup, which may be affixed to the cup once ground coffee is placed into the filter in the cup. The cover may also be formed from the biodegradable composition. In some embodiments, the filter may be formed from a lattice of treads formed from the biodegradable composition, typically containing different additives than the composition used to form the cup and/or the cover. In some embodiments, the biodegradable composition may be formed into a cup by spray application onto a portion of the filter (e.g., walls of the filter).

The stretch blow molding process involves the production of hollow articles, such as bottles, having biaxial molecular orientation. Biaxial orientation provides enhanced physical properties, clarity, and gas barrier properties, which are all important in articles such as bottles for carbonated beverages.

There are two distinct stretch blow molding techniques. In the one-stage process, preforms are injection molded, conditioned to the proper temperature, and blown into articles in one continuous process. This technique is most effective in specialty applications, such as wide-mouthed jars, where very high production rates are not a requirement.

In the two-stage process, preforms are injection molded, stored for a short period of time (typically 1 to 4 days), and blown into articles using a reheat-blow (RHB) machine. Because of the relatively high cost of molding and RHB equipment, this is the best technique for producing high volume items such as carbonated beverage bottles.

Yet other examples of forming methods that may be suitable for use in forming the biodegradable article are described in U.S. Pat. No. 5,028,461, 6,706,223, 7,611,658, 7,713,045, 7,758,801, 8,268,229, 8,556,621, 8,771,583, 8,772,393, 8,893,908, 9,352,492, 9,574,064, 9,643,351, 9,815,233, 10,040,225, 10,279,526, 10,471,642, 10,844,168, 11,161,293, 11,511,468, and 11,578,200 and U.S. Patent Application Publication Nos. 2007/0145646 and 2022/0289999.

All patent publications and non-patent publications are indicative of the level of skill of those skilled in the art to which this disclosure pertains. All these publications are herein incorporated by reference to the same extent as if each individual publication were specifically and individually indicated as being incorporated by reference.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A biodegradable composition, suitable for use in packaging, comprising an Ulva polysaccharide, a nanomaterial, a non-Ulva biomass, and a non-phthalate plasticizer.

2. The composition of claim 1, wherein the Ulva polysaccharide comprises an ulvan, starch, cellulose, or a combination of two or more thereof.

3. (canceled)

4. The composition of claim 1, wherein the Ulva polysaccharide is a substantially purified ulvan; or
wherein the Ulva polysaccharide comprises from about 41 to about 53.1 mol % rhamnose, about 27 to about 30 mol % glucuronic acid, about 7.4 to about 10.1 mol % iduronic acid, and about 5.3 to about 5.7 mol % xylose; or
wherein the Ulva polysaccharide is a substantially purified cellulose; or
wherein the Ulva polysaccharide is a substantially purified starch; or
wherein the Ulva polysaccharide is obtained from Ulva lactuca, Ulva fasciata, Ulva ohnoi, Ulva prolifera, Ulva armoricans, U. australis, U. rigida, U. linza, U reticulata, U. ralfsii, U. compressa, U. pertusa, U. intestinalis, U. flexuosa, U. californica, U. curvata, U. digitata, U. clathrate, U. scandinavica, U. adhaerens, U. spathulate, or a combination of two or more thereof.

5. (canceled)

6. (canceled)

7. (canceled)

8. (canceled)

9. (canceled)

10. The composition of claim 1, wherein the Ulva polysaccharide is chemically modified and wherein the modified Ulva polysaccharide comprises a reactive chemical moiety selected from an acryloyl group, hydroxyl group, amino group, ε-amino group, carboxylic acid group, carboxylate group, g-carboxyamide group, cationic group, anionic group, or a combination of two or more thereof, optionally wherein the Ulva polysaccharide is in the form of a hydrogel.

11. (canceled)

12. (canceled)

13. The composition of claim 1, wherein the non-phthalate plasticizer is a biological plasticizer.

14. The composition of claim 13, wherein the non-phthalate plasticizer is a decarbonate; or
wherein the biological plasticizer is obtained from starch, cellulose, vegetable oil, Tall-oil, citric acid, lecithin, wax, amino acids, or a combination of two or more thereof, or
wherein the biological plasticizer comprises acetylated castor oil, epoxidized soybean oil, methyl epoxy soyate, amyl epoxy soyate, nonyl epoxy soyate, di-caprylsebacate, acetylated ester, octyl epoxy stearate, tall-oil fatty esters, epoxidized soybean oil fatty esters, a fatty ester, cardanol acetate, glycerol, or a combination of two or more thereof
wherein the non-phthalate plasticizer comprises an organic polymer, an aliphatic dibasic acid ester, a benzoate ester, a trimellitate ester, a polyester, a citrate, or a combination of two or more thereof.

15. (canceled)

16. (canceled)

17. (canceled)

18. The composition of claim 14, wherein the organic polymer comprises sorbitol, glycerol, mannitol, sucrose, polyethylene glycol (PEG), propylene glycol, an epoxidized vegetable oil, or a combination of two or more thereof.

19. The composition of claim 18, wherein the epoxidized vegetable oil comprises epoxidized soybean oil (ESBO), epoxidized linseed oil (ELO), castor oil, palm oil, or a combination of two or more thereof; or
wherein the aliphatic dibasic acid ester comprises a glutarate, an adipate, an azelate, a sebacate, or a combination of two or more thereof; or
wherein the benzoate ester comprises diethylene glycol dibenzoate (DEGDB), dipropylene glycol dibenzoate (DPGDB), triethylene glycol dibenzoate (TEGDB), 1,2-propylene glycol dibenzoate (PGDB), isodecyl benzoate, isononyl benzoate, 2-ethylhexyl benzoate, dipropylene glycol monobenzoate, diethylene glycol monobenzoate, or a combination of two or more thereof; or
wherein the trimellitate ester comprises tri-2-ethylhexyl trimellitate (TOTM), tri-n-octyl trimellitate (n-TOTM), triisononyl trimellitate (TINTM), or a combination of two or more thereof; or
wherein the polyester, comprises polyethylene terephthalate, poly-1, 4-cyclohexylene-dimethylene terephthalate, a plant-based polyester, or a combination of two or more thereof; or
wherein the citrate comprises a citric acid ester, tributyl citrate, an acetylated tributyl citrate, acetyl (2-ethylhexyl) citrate, or a combination of two or more thereof.

20. (canceled)

21. (canceled)

22. (canceled)

23. (canceled)

24. (Canceled)

25. The composition of claim 1, wherein the non-phthalate plasticizer comprises about 1% to about 2% w/v of the composition.

26. The composition of claim 1, wherein the non-Ulva biomass comprises an algal biomass, a plant biomass, a mycelial biomass, or a combination of two or more thereof.

27. The composition of claim 26, wherein the biomass comprises almond waste, wood waste, red seaweed biomass, brown seaweed biomass, lignocellulose, starch, chitin, chitosan, or a combination of two or more thereof; or
wherein the biomass is substantially purified.

28. (canceled)

29. The composition of claim 27, wherein the substantially purified biomass is carrageenan, agar, or a mix of carrageenan and agar; or
wherein the substantially purified biomass is alginate, fucoidan, or a mix of alginate and fucoidan.

30. (canceled)

31. The composition of claim 1, further comprising an additive.

32. The composition of claim 31, wherein the additive comprises a stabilizer, a nucleating agent, a clarifying agent, a flame retardant, an antioxidant, a colorant, a filler, water, a preservative, a moisture barrier agent, a gas barrier agent, an anti-static agent, a coupling agent, a curing agent, a foaming/blowing agent, an impact modifier, a lubricant, a processing aid, or a combination of two or more thereof;
optionally wherein the stabilizer comprises a heat stabilizer, an UV stabilizer, an oxidation stabilizer, an ozonolysis stabilizer, a photo-oxidation stabilizer, or a combination of two or more thereof.

33. (canceled)

34. (canceled)

35. (canceled)

36. The composition of claim 1, wherein the nanomaterial comprises biological nanomaterials, natural nanomaterials, synthetic nanomaterials, or a combination of two or more thereof; or
wherein the nanomaterial comprises silica nanoparticles, titanium oxide nanoparticles, zinc oxide nanoparticles, copper oxide nanoparticles, silver nanoparticles, gold nanoparticles, carbon nanotubes, or a combination of two or more thereof; or
wherein at least a portion of the Ulva polysaccharide is coated onto the nanomaterial.

37. (canceled)

38. (canceled)

39. The composition of claim 1, wherein Ulva polysaccharide has a glass transition temperature (Tg) about 110 to about 150° C.

40. The composition of claim 1, which is in the form of a resin.

41. The composition of claim 40, wherein the resin is in the form of dry granules, wet pulps, dry powder, dry flakes, capsules, and wet pastes, or a combination of two or more thereof.

42. The composition of claim 1, further comprising a propellent.

43. An aerosol container containing the biodegradable composition of claim 41.

44. A biodegradable article, having a desired shape and size and which comprises the composition of claim 1.

45. The article of claim 44, which is a coating, a film, a sheet, or a packaging material.

46. The article of claim 45, wherein the coating has a thickness of about 0.1 μm to about 0.10 mm; or
wherein the film has a thickness of about 0.11 to about 0.25 mm; or
wherein the film has a thickness of about 0.11 to about 0.17 mm or about 0.25 to about 0.5 mm; or
wherein the sheet has a thickness of about 0.25 to about 0.5 mm.

47. (canceled)

48. (canceled)

49. (canceled)

50. (canceled)

51. (canceled)

52. (canceled)

53. The article of claim 45, wherein the packaging material is a thermoformed insert, sheet, sachet, laminate, banner, loose fill, bubble wrap, box inner lining, netting, seed strip, twine, tie, clip, tape, thread, glove, mask, gown, or textile.

54. The article of claim 44, which is in the form of a package selected from a clamshell, blister pack, box, bag, bottle, tray, cup, lid, tub, pouch, jar, capsule, pot, plate, straw, utensil, tie, clip, tape, thread, glove, mask, gown, and textile.

55. (canceled)

56. The article of claim 44, wherein the non-Ulva biomass comprises chitosan and the nanomaterial comprises graphite carbon nitride; or
wherein the non-Ulva biomass comprises carboxymethyl cellulose and the nanomaterial comprises cobalt-based metal-organic framework nanomaterials; or
wherein the non-Ulva biomass comprises glucomannan and chitosan, the nanomaterial comprises zinc oxide nanoparticles or pullulan nanomaterials; or
wherein the non-Ulva biomass comprises carboxymethyl chitosan and the nanomaterial comprises copper oxide nanoparticles; or
wherein the non-Ulva biomass comprises gelatin and chitosan and the nanomaterial comprises oxidized cellulose nanofibers.

57. (canceled)

58. (canceled)

59. (canceled)

60. (canceled)

61. The article of claim 56, wherein the additive comprises an anthocyanin, curcumin, cinnamon oil, or a combination of two or more thereof.

62. The article of claim 44, which has a moisture content of about 10 to about 32%; or
which has a water vapor permeability (WVP) of about 1 to about 4.5×10⁸ g mm/cm² s Pa; or
which has a transparency of about 0.5 to about 10 absorbance at 600 nm per mm thickness of the article (A600/mm); or
which has a tensile strength of about 0.1 to about 4 megapascals (MPa).

63. (canceled)

64. (canceled)

65. (canceled)

66. The article of claim 44, further comprising a label disposed on the article.

67. The article of claim 66, wherein the label comprises information relating to the article, the process in which it was created, and/or the company that produced the article.

68. The article of claim 67, wherein the information relates to quantifiable units of carbon capture, reduced greenhouse gas (GHG) emissions, energy consumed in the production of the Ulva, energy consumed in the production of the article, waste effluents, pollutants, downstream impacts, certification marks, ecolabels, information relating to compostability of the article, reduced water usage, reduced transport costs, specific energy sources, ecological co-benefits, carbon accounting protocol type, tracking codes, or a combination of two or more thereof.

69. A method of forming a biodegradable article, comprising:
a. preparing the composition of any one of claim 1; and
b. forming the article into a desired shape and size.

70. (canceled)

71. (canceled)

72. (canceled)

73. (canceled)

74. (canceled)

75. (canceled)

76. (canceled)
